(19) United States
(12) Patent Application Publication
(10) Pub. No.: US 2025/0173388 A1
(43) Pub. Date: May 29, 2025

(54) Systems and Methods for Co-discovering Graphical Structure and Functional Relationships Within Data

(71) Applicant: California Institute of Technology, Pasadena, CA (US)

(72) Inventors: Houman Owhadi, La Crescenta, CA (US); Nicolas F. Rouquette, Pasadena, CA (US); Pau Batlle Franch, Pasadena, CA (US); Theo Bourdais, Pasadena, CA (US); Xianjin Yang, Pasadena, CA (US); Ricardo Baptista, Pasadena, CA (US)

(73) Assignee: California Institute of Technology, Pasadena, CA (US)

(21) Appl. No.: 18/962,595

(22) Filed: Nov. 27, 2024

Related U.S. Application Data
(60) Provisional application No. 63/603,035, filed on Nov. 27, 2023.

(51) Int. Cl. G06F 17/10

(52) U.S. Cl. CPC G06F 17/10

(57) ABSTRACT

Systems and methods for hypergraph discovery in accordance with embodiments of the invention include a method of processing input data, comprising receiving input data at a data processing system, providing the input data to a discovered hypergraph, and generating an output using the discovered hypergraph, wherein the discovered hypergraph is characterized by a plurality of relationships between a plurality of nodes that each represent a variable of a plurality of variables, where the plurality of relationships were discovered by selection of a kernel for a relationship between at least one node of the plurality of nodes and a set of candidate ancestors, and pruning of the set of candidate ancestors to identify a set of minimal ancestors.

### CROSS-REFERENCE TO RELATED APPLICATIONS

The current application claims the benefit of and priority under 35 U.S.C. § 119(e) to U.S. Provisional Patent Application No. 63/603,035 entitled “Computational Hypergraph Discovery” filed Nov. 27, 2023. The disclosure of U.S. Provisional Patent Application No. 63/603,035 is hereby incorporated by reference in its entirety for all purposes.

### STATEMENT OF FEDERAL SUPPORT

This invention was made with government support under Grant No. DE-SC0023163 awarded by DOE and under Grant No. FA9550-20-1-0358 awarded by AFOSR. The government has certain rights in the invention.

### FIELD OF THE INVENTION

The present invention generally relates to hypergraph discovery and, more specifically, discovering graphical structure and functional relationships within data.

### BACKGROUND

Previous approaches to discovering hypergraphs have typically involved analyzing relationships between nodes in a dataset to identify complex patterns and structures. Traditional methods for analyzing relationships in data have included techniques such as graph theory, network analysis, and clustering algorithms. These methods may not capture higher-order relationships that exist in the data. As a result, these approaches may not fully capture the intricate relationships and dependencies present in complex datasets, limiting the ability to uncover hidden patterns and structures.

Other approaches have focused on using machine learning techniques to discover relationships in data. These methods typically involve training models to learn relationships between inputs and outputs but may struggle to efficiently learn relationships between unrelated variables.

### SUMMARY OF THE INVENTION

Systems and methods for hypergraph discovery in accordance with embodiments of the invention are illustrated. One embodiment includes a method of processing input data, comprising receiving input data at a data processing system, providing the input data to a discovered hypergraph, and generating an output using the discovered hypergraph, wherein the discovered hypergraph is characterized by a plurality of relationships between a plurality of nodes that each represent a variable of a plurality of variables, where the plurality of relationships were discovered by selection of a kernel for a relationship between at least one node of the plurality of nodes and a set of candidate ancestors, and pruning of the set of candidate ancestors to identify a set of minimal ancestors.

In a further embodiment, the plurality of relationships were further discovered by selection of a different second kernel for a second relationship between a second node of the plurality of nodes and a corresponding set of candidate ancestors.

In still another embodiment, the kernel is at least one selected from the group consisting of a linear kernel, a quadratic kernel, and a nonlinear kernel.

In a still further embodiment, generating the output includes generating a set of control signals for controlling a physical device.

In yet another embodiment, the physical device is a vehicle.

In a yet further embodiment, receiving the set of input data includes normalizing the set of input data.

In another additional embodiment, normalizing the data includes performing affine transformations.

In a further additional embodiment, the selection of a kernel is based on a set of training data, the set of training data includes a plurality of samples, a first sample includes values for a first subset of the plurality of variables, and a second sample includes values for a different second subset of the plurality of variables.

In another embodiment again, selection of a kernel comprises for each of a plurality of kernels computing a signal-to-noise ratio (SNR) for the relationship between the selected node and the set of candidate ancestors, and when the SNR falls below a given threshold, selecting the kernel for the relationship between the selected node and the set of candidate ancestors.

In a further embodiment again, the plurality of kernels includes at least one selected from the group consisting of a linear kernel, a quadratic kernel, and a nonlinear kernel.

In still yet another embodiment, computing the SNR comprises selecting a noise prior parameter, and performing a regression analysis with the selected noise prior parameter.

In a still yet further embodiment, performing the regression analysis includes predicting a value of the selected node based on the set of candidate ancestors.

In still another additional embodiment, the SNR is a ratio of a mean and a variance for predicted values of the selected node based on the set of candidate ancestors.

In a still further additional embodiment, the given threshold is a fixed value.

In still another embodiment again, at least one of the plurality of kernels is at least one selected from the group consisting of a Gaussian kernel and a Matérn kernel.

In a still further embodiment again, the set of candidate ancestors includes all of the plurality of nodes other than the selected node.

In yet another additional embodiment, pruning the set of candidate ancestors comprises identifying a least important ancestor of the set of candidate ancestors, computing a signal-to-noise (SNR) for the relationship between the selected node and the set of candidate ancestors without the least important ancestor, when the computed SNR exceeds a given threshold, select the set of candidate ancestors without the least important ancestor as the set of minimal ancestors, and when the computed SNR falls below a given threshold, select the set of candidate ancestors as the set of minimal ancestors.

In a yet further additional embodiment, pruning the set of candidate ancestors comprises for each of a plurality of subsets of the set of candidate ancestors, computing a noise-to-signal ratio (NSR) for the relationship between the selected node and the subset of candidate ancestors, identifying a particular subset of the plurality of subsets as the set of minimal ancestors based on the computed NSRs for the plurality of subsets.

In yet another embodiment again, computing the NSR comprises selecting a noise prior parameter, and performing a regression analysis with the selected parameter.

In a yet further embodiment again, performing the regression analysis includes predicting a value of the selected node based on the set of candidate ancestors.

In another additional embodiment again, the NSR is a ratio of a mean and a variance for predicted values of the selected node based on the set of candidate ancestors.

In a further additional embodiment again, the regression analysis is a Kernel Ridge Regression.

In still yet another additional embodiment, the noise prior parameter is selected based on characteristics of the kernel.

In a further embodiment, selecting the noise prior parameter includes maximizing the variance of an eigenvalue histogram when the kernel is a universal kernel.

In still another embodiment, identifying the particular subset includes identifying an inflection point in the NSRs as a function of a number of ancestors in the subset of candidate ancestors.

In a still further embodiment, selecting the kernel and pruning the set of candidate ancestors is based on a same threshold.

In yet another embodiment, pruning the set of candidate ancestors comprises identifying a set of redundant candidate ancestors of the set of candidate ancestors, and removing at least one candidate ancestor of the set of redundant candidate ancestors from the set of candidate ancestors, wherein redundant candidate ancestors make redundant contributions to the computed NSR.

In a yet further embodiment, identifying the set of redundant candidate ancestors is based on the determined relationships between the plurality of nodes.

In another additional embodiment, the plurality of relationships were further discovered by identifying clusters of nodes of the plurality of nodes based on relationships between each node and the set of candidate ancestors of the node, and identifying relationships between the clusters of nodes, wherein the plurality of relationships comprises the relationships between each node and the set of candidate ancestors of the node, and the relationships between the clusters of nodes.

One embodiment includes a data processing system, comprising at least one processor, a memory, wherein machine readable instructions stored in the memory configure the processor to perform a method comprising receiving input data at a data processing system, providing the input data to a discovered hypergraph, and generating an output using the discovered hypergraph, wherein the discovered hypergraph is characterized by a plurality of relationships between a plurality of nodes that each represent a variable of a plurality of variables, where the plurality of relationships were discovered by selection of a kernel for a relationship between at least one node of the plurality of nodes and a set of candidate ancestors, and pruning of the set of candidate ancestors to identify a set of minimal ancestors.

One embodiment includes a method for hypergraph discovery. The method includes steps for receiving a set of input data includes a plurality of samples, each sample includes values for at least a subset of a plurality of variables, determining relationships between a plurality of nodes based on the set of input data, each node of the plurality of node representing a variable of the plurality of variables, wherein determining relationships for each node of the plurality of nodes comprises selecting a kernel for a relationship between a selected node and a set of candidate ancestors, and pruning the set of candidate ancestors to identify a set of minimal ancestors, and generating a hypergraph of the input data based on the relationships between the plurality of nodes.

In a further additional embodiment, receiving the set of input data includes normalizing the set of input data.

In another embodiment again, normalizing the data includes performing affine transformations.

In a further embodiment again, the set of input data includes a plurality of samples, a first sample includes values for a first subset of the plurality of variables, and a second sample includes values for a different second subset of the plurality of variables.

In still yet another embodiment, selecting a kernel comprises for each of a plurality of kernels computing a signal-to-noise ratio (SNR) for the relationship between the selected node and the set of candidate ancestors, and when the SNR falls below a given threshold, selecting the kernel for the relationship between the selected node and the set of candidate ancestors.

In a still yet further embodiment, the plurality of kernels includes at least one selected from the group consisting of a linear kernel, a quadratic kernel, and a nonlinear kernel.

In still another additional embodiment, computing the SNR comprises selecting a noise prior parameter, and performing a regression analysis with the selected noise prior parameter.

In a still further additional embodiment, performing the regression analysis includes predicting a value of the selected node based on the set of candidate ancestors.

In still another embodiment again, the SNR is a ratio of a mean and a variance for predicted values of the selected node based on the set of candidate ancestors.

In a still further embodiment again, the given threshold is a fixed value.

In yet another additional embodiment, at least one of the plurality of kernels is at least one selected from the group consisting of a Gaussian kernel and a Matérn kernel.

In a yet further additional embodiment, the set of candidate ancestors includes all of the plurality of nodes other than the selected node.

In yet another embodiment again, pruning the set of candidate ancestors comprises identifying a least important ancestor of the set of candidate ancestors, computing a signal-to-noise (SNR) for the relationship between the selected node and the set of candidate ancestors without the least important ancestor, when the computed SNR exceeds a given threshold, select the set of candidate ancestors without the least important ancestor as the set of minimal ancestors, and when the computed SNR falls below a given threshold, select the set of candidate ancestors as the set of minimal ancestors.

In a yet further embodiment again, pruning the set of candidate ancestors comprises for each of a plurality of subsets of the set of candidate ancestors, computing a noise-to-signal ratio (NSR) for the relationship between the selected node and the subset of candidate ancestors, identifying a particular subset of the plurality of subsets as the set of minimal ancestors based on the computed NSRs for the plurality of subsets.

In another additional embodiment again, computing the NSR comprises selecting a noise prior parameter, and performing a regression analysis with the selected parameter.

In a further additional embodiment again, performing the regression analysis includes predicting a value of the selected node based on the set of candidate ancestors.

In still yet another additional embodiment, the NSR is a ratio of a mean and a variance for predicted values of the selected node based on the set of candidate ancestors.

In a further embodiment, the regression analysis is a Kernel Ridge Regression.

In still another embodiment, the noise prior parameter is selected based on characteristics of the kernel.

In a still further embodiment, selecting the noise prior parameter includes maximizing the variance of an eigenvalue histogram when the kernel is a universal kernel.

In yet another embodiment, identifying the particular subset includes identifying an inflection point in the NSRs as a function of a number of ancestors in the subset of candidate ancestors.

In a yet further embodiment, selecting the kernel and pruning the set of candidate ancestors is based on a same threshold.

In another additional embodiment, pruning the set of candidate ancestors comprises identifying a set of redundant candidate ancestors of the set of candidate ancestors, and removing at least one candidate ancestor of the set of redundant candidate ancestors from the set of candidate ancestors, wherein redundant candidate ancestors make redundant contributions to the computed NSR.

In a further additional embodiment, identifying the set of redundant candidate ancestors is based on the determined relationships between the plurality of nodes.

In another embodiment again, the method further includes steps for identifying clusters of nodes of the plurality of nodes based on relationships between each node and the set of minimal ancestors of the node, and identifying relationships between the clusters of nodes, wherein generating the hypergraph of the input data is further based on the relationships between the clusters of nodes.

One embodiment includes an apparatus comprising a set of one or more processors, a set of one or more peripherals, and a non-transitory machine readable medium containing program instructions that are executable by the set of processors to perform a method that includes steps for receiving a set of input data includes a plurality of samples, each sample includes values for at least a subset of a plurality of variables, determining relationships between a plurality of nodes based on the set of input data, each node of the plurality of node representing a variable of the plurality of variables, wherein determining relationships for each node of the plurality of nodes comprises selecting a kernel for a relationship between a selected node and a set of candidate ancestors, and pruning the set of candidate ancestors to identify a set of minimal ancestors, generating a hypergraph of the input data based on the relationships between the plurality of nodes, and controlling the apparatus based on the generated hypergraph.

In a further embodiment again, the set of input data includes data collected from at least one peripheral of the set of peripherals.

In still yet another embodiment, the set of peripherals includes at least one selected from the group consisting of a gyroscope, an accelerometer, an odometer, a LiDAR system, an environmental sensor, and a motion sensor.

One embodiment includes a non-transitory machine readable medium containing program instructions that are executable by a set of one or more processors to perform a method that includes steps for receiving a set of input data includes a plurality of samples, each sample includes values for at least a subset of a plurality of variables, determining relationships between a plurality of nodes based on the set of input data, each node of the plurality of node representing a variable of the plurality of variables, wherein determining relationships for each node of the plurality of nodes comprises selecting a kernel for a relationship between a selected node and a set of candidate ancestors, and pruning the set of candidate ancestors to identify a set of minimal ancestors, and generating a hypergraph of the input data based on the relationships between the plurality of nodes.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates representations of Type 1, Type 2, and Type 3 problems.

FIG. 2 conceptually illustrates a process for hypergraph discovery in accordance with an embodiment of the invention.

FIG. 3 conceptually illustrates a process for kernel selection in accordance with an embodiment of the invention.

FIG. 4 conceptually illustrates a process for pruning ancestors based on a threshold in accordance with an embodiment of the invention.

FIG. 5 conceptually illustrates a process for pruning ancestors based on a difference between successive noise-to-signal ratios in accordance with an embodiment of the invention.

FIG. 6 illustrates examples of challenges that can be addressed with hypergraph discovery in accordance with various embodiments of the invention.

FIG. 7 illustrates a resultant computational graph of the recovery of a chemical reaction network.

FIG. 8 illustrates an example of a hypergraph discovery process in accordance with an embodiment of the invention.

FIG. 9 illustrates an example of pruning ancestors in accordance with an embodiment of the invention.

FIG. 10 illustrates an example of an analysis of NSR in accordance with an embodiment of the invention.

FIG. 11 illustrates an example of result data from an analysis of a FPUT system.

FIG. 12 illustrates another example of an analysis of NSR in accordance with an embodiment of the invention.

FIG. 13 illustrates an example of hypergraph discovery as a manifold discovery problem and hypergraph representation and the hypergraph representation of an affine manifold in accordance with an embodiment of the invention.

FIG. 14 illustrates an example of feature map generalization in accordance with an embodiment of the invention.

FIG. 15 illustrates an example of histograms of eigenvalues of Dy.

FIG. 16 illustrates examples of the recovery of functional dependencies from data in accordance with an embodiment of the invention.

FIG. 17 illustrates an example of hypergraph discovery with COVID-19 data in accordance with an embodiment of the invention.

FIG. 18 illustrates an example of the evolution of the observed signal-to-noise ratio when pruning ancestors in accordance with an embodiment of the invention.

FIG. 19 illustrates an example of hypergraph discovery in biological cellular signaling networks in accordance with an embodiment of the invention.

FIG. 20 illustrates an example of a hypergraph discovery system that performs hypergraph discovery in accordance with an embodiment of the invention.

FIG. 21 illustrates an example of a hypergraph discovery element that executes instructions to perform processes that perform hypergraph discovery in accordance with an embodiment of the invention.

### DETAILED DESCRIPTION

Many complex data analysis problems within and beyond the scientific domain involve discovering graphical structures and functional relationships within data. Nonlinear variance decomposition with Gaussian Processes in accordance with a number of embodiments of the invention simplifies and automates this process. Other methods, such as Artificial Neural Networks, lack this variance decomposition feature. Information-theoretic and causal inference methods suffer from super-exponential complexity with respect to the number of variables. Systems and methods in accordance with certain embodiments of the invention perform this task in polynomial complexity. This unlocks the potential for applications involving the identification of a network of hidden relationships between variables without a parameterized model at an unprecedented scale, scope, and complexity.

Most problems within and beyond the scientific domain can be framed into one of the following three levels of complexity of function approximation. Type 1: Approximate an unknown function given (possibly noisy) input/output data. Type 2: Consider a collection of variables and functions, some of which are unknown, indexed by the nodes and hyperedges of a hypergraph (a generalized graph where edges can connect more than two vertices). Given partial observations of the variables of the hypergraph (satisfying the functional dependencies imposed by its structure), approximate all the unobserved variables and unknown functions. Type 3: Expanding on Type 2, if the hypergraph structure itself is unknown, use partial observations of (subsets of) the variables of the hypergraph to discover its structure (the hyperedges and possibly the missing vertices) and approximate its unknown functions and/or unobserved variables. These hypergraphs offer a natural platform for organizing, communicating, and processing computational knowledge. While most Computational Science and Engineering and Scientific Machine Learning challenges can be as the data-driven discovery of unknown functions in a computational hypergraph whose structure is known (Type 2), many require the data-driven discovery of the structure (connectivity) of the hypergraph itself (Type 3). Despite their prevalence, these Type 3 challenges have been largely overlooked due to their inherent complexity.

Although Gaussian Process (GP) methods are sometimes perceived as well-founded but old technology limited to Type 1 curve fitting, their scope has recently been expanded to Type 2 problems. Systems and methods in accordance with numerous embodiments of the invention introduce an interpretable Gaussian Process (GP) framework for Type 3 problems that does not require randomization of the data, nor access to or control over its sampling, nor sparsity of the unknown functions in a known or learned basis. Its polynomial complexity, which contrasts sharply with the super-exponential complexity of causal inference methods, is enabled by the nonlinear analysis of variance capabilities of GPs used as a sensing mechanism. Hypergraph discovery in accordance with various embodiments of the invention allows for hypergraphs to be generated in a computationally efficient manner, where the hypergraphs enable the efficient computation of outputs based on a set of inputs. In a variety of embodiments, hypergraph discovery can enable such efficiencies by identifying ancestors using one or more kernels and pruning.

Systems and methods in accordance with many embodiments of the invention are based on a kernel generalization of (1) Row Echelon Form reduction from linear systems to nonlinear ones and/or (2) variance-based analysis. In many embodiments, variables can be linked via GPs, and those contributing to the highest data variance can unveil a hypergraph's structure. The scope and efficiency of processes in accordance with a number of embodiments of the invention are illustrated below with applications to (algebraic) equation discovery, network discovery (gene pathways, chemical, and mechanical), and raw data analysis.

The scope of Type 1, 2, and 3 problems is immense. Numerical approximation, Supervised Learning, and Operator Learning can all be formulated as type 1 problems i.e., as approximating unknown functions given (possibly with noisy and infinite/high-dimensional) inputs/output data. The common GP-based solution to these problems is to replace the underlying unknown function by a GP and compute its MAP estimator given available data. Type 2 problems include solving and learning (possibly stochastic) ordinary or partial differential equations, Deep Learning, dimension reduction, reduced-ordered modeling, system identification, closure modeling, etc.

The scope of Type 3 problems extends well beyond Type 2 problems and includes applications involving model/equation/network discovery and reasoning with raw data. While most problems in Computational Sciences and Engineering (CSE) and Scientific Machine Learning (SciML) can be framed as Type 1 and Type 2 challenges, many problems in science can only be categorized as Type 3 problems, i.e., discovering the structure/connectivity of the graph itself from data prior to its completion. Despite their prevalence, these Type 3 challenges have been largely overlooked due to their inherent complexity.

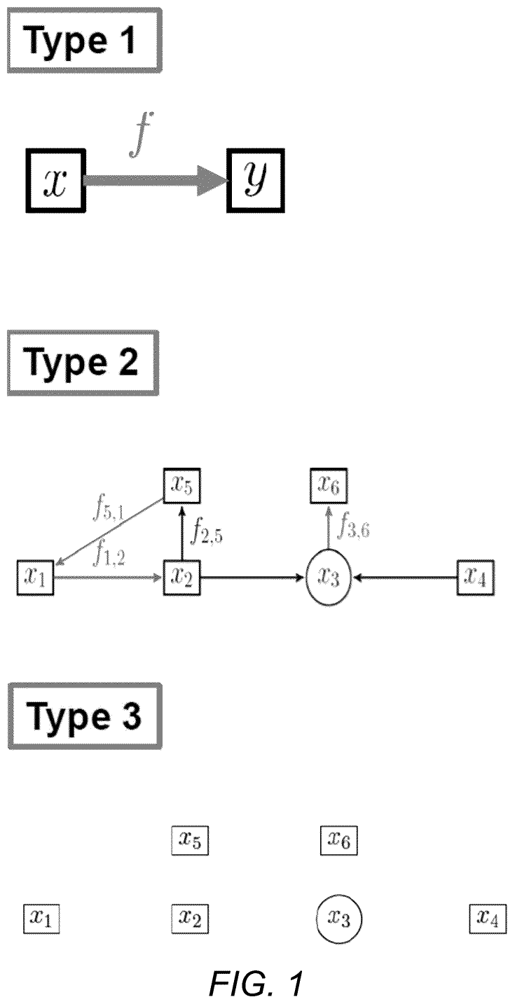

Type 1, Type 2, and Type 3 problems can be formulated as completing or discovering hypergraphs where nodes represent variables and edges represent functional dependencies. Representations of Type 1, Type 2, and Type 3 problems are illustrated in FIG. 1. In this figure, the graph for Type 1 has only two variables and one unknown function. The graph for Type 2 has multiple variables and (some possibly unknown) functions, and the connectivity of the graph is known. The graph for Type 3 has an unknown connectivity (functional dependencies between variables may be unknown) and this is the focus of this work. Current methods for solving Type 1 and 2 problems include Deep Learning (DL) methods, which benefit from extensive hardware and software support but have limited guarantees.

Other potential avenues for addressing Type 3 problems include causal inference methods, probabilistic graphs, and sparse regression methods. However, it is important to note that their application to these problems necessitates additional assumptions. Causal inference models, for instance, typically assume randomized data and some level of access to the data generation process or its underlying distributions. Unlike causal inference models, systems and methods in accordance with certain embodiments of the invention seek to encode the functional dependencies between variables into the structure of the graph. Sparse regression methods, on the other hand, rely on the assumption that functional dependencies have a sparse representation within a known basis. Systems and methods in accordance with many embodiments of the invention do not rely on such assumptions. Furthermore, while the complexity of Bayesian causal inference methods may grow super-exponentially with the number d of variables, the complexity of processes in accordance with several embodiments of the invention is that of d parallel computations of polynomial complexities bounded between O(d) (best case) and O(d⁴) (worst case).

A detailed analysis of the computational demands of systems and methods in accordance with certain embodiments of the invention as a function of the number of variables, denoted as d, and the number of samples, N, pertaining to these variables follows. In the worst case, the proposed approach necessitates, for each of the d variables: for i=1, . . . , d−1, regressing a function mapping d−i variables to the variable of interest and performing a mode decomposition to identify the variable with the minimal contribution to the signal. Since these two steps have the same cost, it follows that, in the worst case, the total computational complexity of the proposed method is O(d² N³) which corresponds to the product of the number of double-looping operations, d², and the cost of kernel regression from N samples which, without acceleration, is N³ (i.e., the cost of inverting a N×N dense kernel matrix).

However, if kernel scalability techniques are utilized, such as when the kernel has a rank k (for example, k=d if the kernel is linear) or is approximated by a kernel of rank k (e.g., via a random feature map), then this worst-case bound can be reduced to 0 (d²Nk²) by reducing the complexity of each regression step from O(N³) to O(Nk²). Note that the statistical accuracy of the proposed approach requires that N>d if the dependence of the unknown functions on their inputs is not sparse. Moreover, in the absence of kernel scalability techniques, the worst-case memory footprint of the method is O(N²) due to the necessity of handling dense kernel matrices. However, once the functional ancestors of each variable are determined, these matrices can be discarded. Consequently, only one such matrix needs to be retained in memory at any given time.

### 1. Processes for Hypergraph Discovery

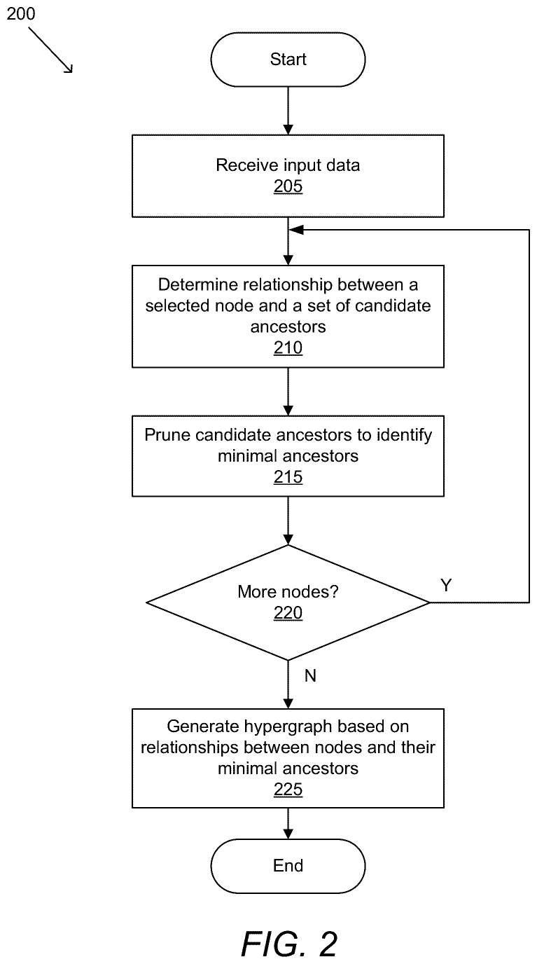

A process for hypergraph discovery in accordance with an embodiment of the invention is conceptually illustrated in FIG. 2. Process 200 receives (205) input data. Input data in accordance with many embodiments of the invention includes sample values for multiple different variables. In many embodiments, input data includes nodes for a hypergraph, where each node represents a different variable. Nodes of the input data in accordance with certain embodiments of the invention may be disconnected. Input data in accordance with numerous embodiments of the invention include samples, where different samples may include values for different subsets (or all) of the variables. In a number of embodiments, input data is encoded into a matrix of values for each (or for subsets) of the variables (or nodes). Processes in accordance with a number of embodiments of the invention normalize the data via various methods, including (but not limited to) affine transformations.

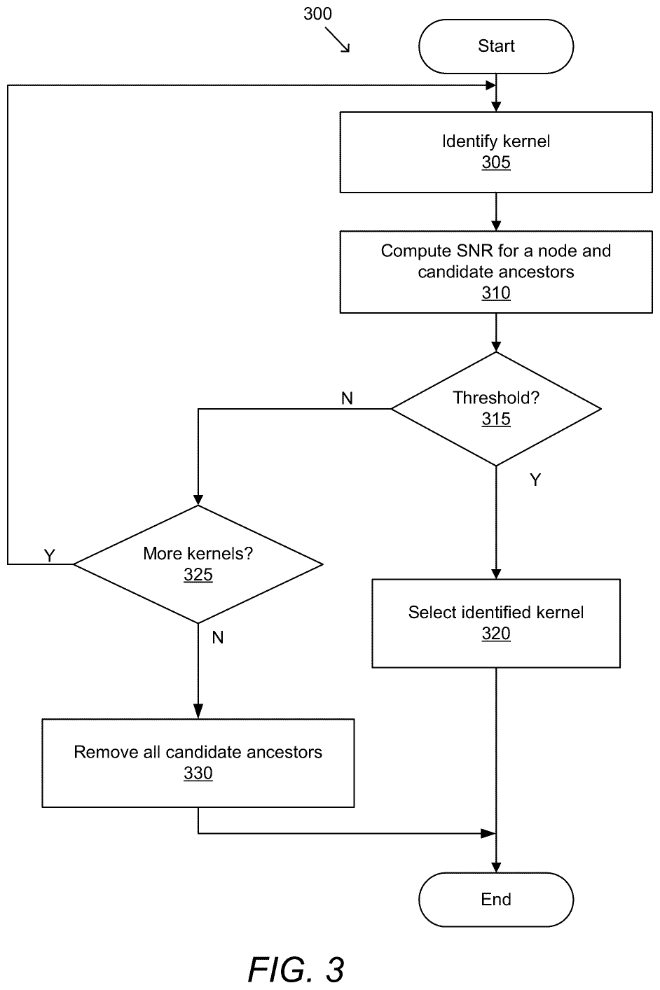

Process 200 determining (210) a relationship between a selected node and a set of candidate ancestors. In a number of embodiments, candidate ancestors for each node may include all the remaining nodes from the input data. In a variety of embodiments, determining a relationship includes selecting a kernel for the relationship. Kernels in accordance with numerous embodiments of the invention can include (but are not limited to) linear, quadratic, and/or nonlinear kernels. Processes in accordance with several embodiments of the invention can select a kernel in an iterative manner, determining whether a kernel can define a function between the candidate ancestors and the selected node with a value that meets (or falls below/above) a threshold. In several embodiments, processes may evaluate multiple kernels and select a best kernel (e.g., best fit). In certain embodiments, the value includes (but is not limited to) a signal-to-noise ratio (SNR), a noise-to-signal ratio (NSR), etc. Thresholds in accordance with many embodiments of the invention can include (but are not limited to) a fixed value (e.g., 0.5) or a computed value. Selecting a kernel in accordance with many embodiments of the invention includes approximating the value of the selected node as a sum of noise and a function of the values of other variables in a given set of ancestors. Kernel selection and determining an SNR to decide whether a node has ancestors in accordance with several embodiments of the invention is described in greater detail below (e.g., with reference to FIG. 3).

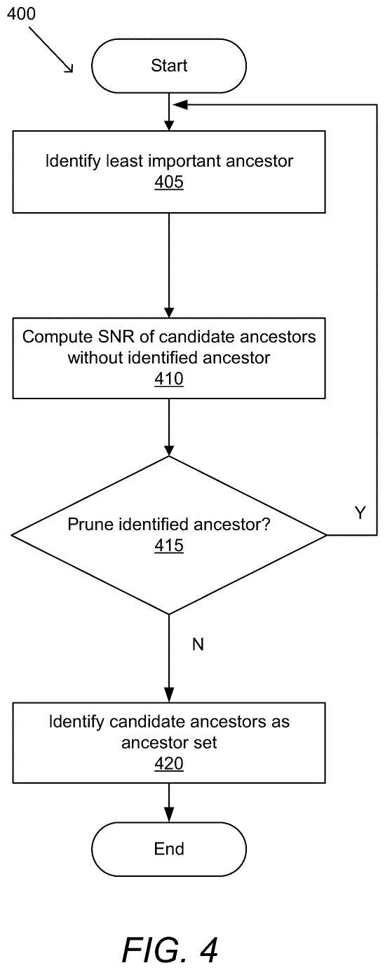

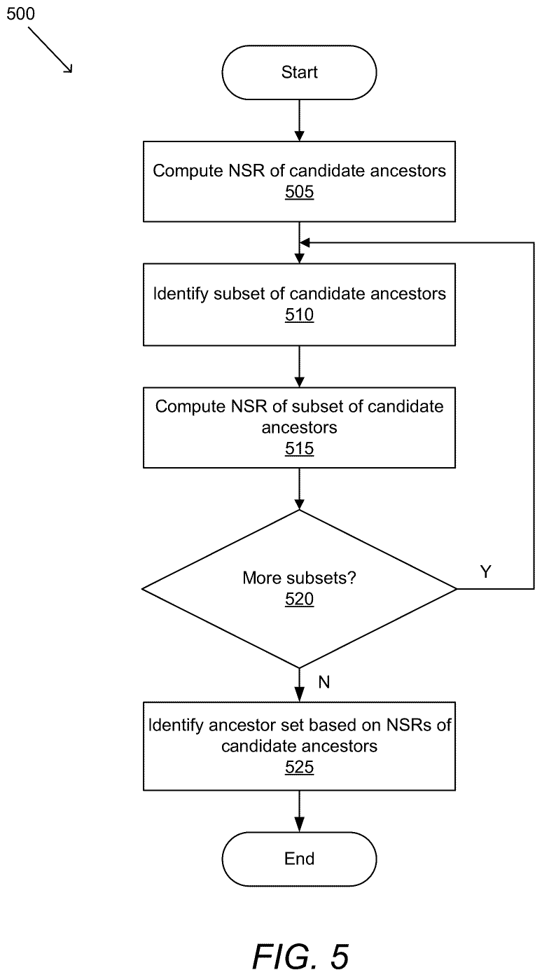

Process 200 prunes (215) the set of candidate ancestors to identify a set of minimal ancestors. In certain embodiments, pruning (or removing) candidate ancestors includes calculating an SNR (or NSR) for the selected node based on the selected kernel and the input data. Processes in accordance with certain embodiments of the invention can perform the pruning in an iterative manner, removing variables that are least contributing to the signal until the value (e.g., SNR, NSR, etc.) meets (or falls below/above) a threshold. In several embodiments, thresholds can include (but are not limited to) a fixed value (e.g., 0.5) or a computed value (e.g., based on the number of candidate ancestors). Processes in accordance with various embodiments of the invention may use a first threshold for selecting a kernel and a second different threshold for pruning the set of candidate ancestors. In some embodiments, pruning ancestors includes computing an NSR for multiple subsets and selecting the set of minimal ancestors based on the computed NSRs. Selecting the set of minimal ancestors in accordance with a number of embodiments of the invention is based on an inflection point in the NSRs as a function of the number of ancestors in the subset. In several embodiments, pruning ancestors includes identifying redundant candidate ancestors and removing redundant candidate ancestors from the set of candidate ancestors. Redundant candidate ancestors in accordance with a number of embodiments of the invention may be ancestors that make the same or otherwise redundant contributions to the SNR (or NSR). In several embodiments, identifying redundant candidate ancestors is based on the determined relationships. Pruning ancestors in accordance with many embodiments of the invention is described in greater detail below (e.g., with reference to FIGS. 4-5).

Process 200 determines (220) whether there are more nodes for which ancestors need to be identified. When the process determines (220) there are more nodes, the process returns to step 210 and selects a kernel for the next selected node. When the process determines (220) there are no more nodes, the process generates (225) the hypergraph based on the selected kernels and relationships between nodes and their minimal ancestors.

In certain embodiments, similar processes may be used at multiple hierarchies (or levels). For example, processes in accordance with a number of embodiments of the invention may identify clusters and identify ancestors with processes similar to those described throughout this description to identify relationships between the identified clusters. In various embodiments,

While specific processes for hypergraph discovery are described above, any of a variety of processes can be utilized for hypergraph discovery as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

Kernel selection in accordance with a number of embodiments of the invention can be used to determine relationships between nodes of a hypergraph. A process for kernel selection in accordance with an embodiment of the invention is conceptually illustrated in FIG. 3. Process 300 identifies (305) a candidate kernel. Kernels in accordance with numerous embodiments of the invention can include (but are not limited to) linear, quadratic, and/or nonlinear kernels.

Process 300 computes (310) an SNR for a node and a set of candidate ancestors based on the identified kernel. Computing an SNR in accordance with several embodiments of the invention includes selecting a noise prior parameter and performing a regression analysis. In a variety of embodiments, the noise prior parameter is selected based on characteristics of the kernel (e.g., whether the kernel is a universal kernel or whether it is derived from a finite-dimensional feature map). Performing a regression analysis can include predicting a value of the node based on the set of candidate ancestors.

Process 300 determines (315) whether the computed SNR meets a threshold. The threshold in accordance with some embodiments of the invention can be a fixed value (e.g., 0.5). When the process determines (315) that the threshold has been met, the process selects (320) the identified kernel. In various embodiments, the identified kernel can be used to prune the set of candidate ancestors. When the process determines (315) that the threshold has not been met, the process determines (325) whether there are more kernels to analyze. When the process determines (325) that there are more kernels, the process returns to step 305 to identify the next kernel. When the process determines (325) that there are no more kernels, the process removes (330) all candidate ancestors for the node.

While specific processes for kernel selection are described above, any of a variety of processes can be utilized for kernel selection as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

Pruning ancestors in accordance with many embodiments of the invention removes ancestors to increase the signal-to-noise ratio (SNR) of the functional relationship between each node and its ancestors. A process for pruning ancestors based on a threshold in accordance with an embodiment of the invention is conceptually illustrated in FIG. 4. In several embodiments, process 400 may be performed once a kernel has been selected and candidate ancestors for a given node have been identified. Process 400 identifies (405) a least important ancestor from the candidate ancestors. In various embodiments, the least important ancestor is the ancestor that contributes the least to the signal.

Process 400 computes (410) the SNR for a node and the candidate ancestors without the identified least important ancestor. Computing an SNR in accordance with several embodiments of the invention includes selecting a noise prior parameter and performing a regression analysis. In a variety of embodiments, the noise prior parameter is selected based on characteristics of the kernel (e.g., whether the kernel is a universal kernel or whether it is derived from a finite-dimensional feature map). Performing a regression analysis can include predicting a value of the node based on the set of candidate ancestors (without the identified least important ancestor). Computing SNRs is described in greater detail below.

Process 400 determines (415) whether to prune the identified ancestor. In a number of embodiments, processes determine whether to prune an ancestor based on whether the computed SNR falls below (or meets) a threshold. Processes in accordance with many embodiments of the invention seek to identify the minimal set of ancestors that maintains an SNR above the threshold.

When the process determines (415) to prune the identified ancestor, the process returns to step 405 to identify the next least important ancestor and repeat the process. When the process determines (415) that the identified ancestor should not be pruned (e.g., when the SNR drops below a threshold), the process identifies (420) the remaining candidate ancestors as the ancestors for the given node.

In certain embodiments, ancestors may be pruned by identifying an optimal set of ancestors. A process for pruning ancestors based on a difference between successive noise-to-signal ratios in accordance with an embodiment of the invention is conceptually illustrated in FIG. 5. Process 500 computes (505) a noise-to-signal ratio (NSR) for a node and its candidate ancestors. Computing an NSR in accordance with a number of embodiments of the invention includes selecting a noise prior parameter and performing a regression analysis with the selected parameter. In a variety of embodiments, the noise prior parameter is selected based on characteristics of the kernel (e.g., whether the kernel is a universal kernel or whether it is derived from a finite-dimensional feature map). Performing a regression analysis can include predicting a value of the node based on the set of candidate ancestors. Computing NSRs is described in greater detail below.

Process 500 identifies (510) a subset of the candidate ancestors. In certain embodiments, the subset of the candidate ancestors is identified by removing one or more of the least important candidate ancestors.

Process 500 computes (515) the NSR of the subset of candidate ancestors. Process 500 determines (520) whether there are more subsets to process. When the process determines (520) there are more subsets to process, the process returns to step 505 to identify the next least important ancestor and repeat the process. When the process determines (515) that the identified ancestor should not be pruned (e.g., when the SNR drops below a threshold), the process identifies (520) the remaining candidate ancestors as the ancestors for the given node. In a variety of embodiments, identifying the particular subset includes identifying an inflection point in the NSRs as a function of a number of ancestors in the subset of candidate ancestors.

While specific processes for pruning ancestors are described above, any of a variety of processes can be utilized for pruning ancestors as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### 2. Examples of Hypergraph Discovery (Type 3) Problems

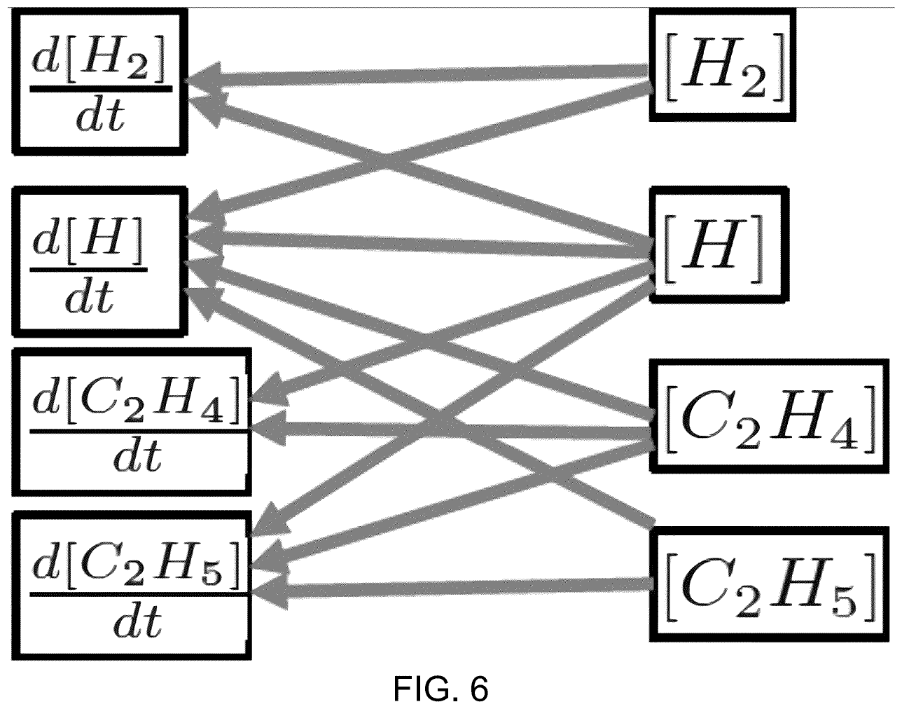

While most problems in Computer Science and Engineering can be framed and resolved as computational graph or hypergraph completion tasks, some scientific challenges necessitate first uncovering the hypergraph's structure before completing it. Systems and methods in accordance with certain embodiments of the invention can be used to tackle challenges in various areas. Examples of these challenges that illustrate the scope and efficiency of the proposed approach are described below. Examples of challenges that can be addressed with hypergraph discovery in accordance with various embodiments of the invention are illustrated in FIG. 6.

One such problem is the recovery of chemical reaction networks from concentration snapshots. As an example consider the hydrogenation of ethylene (C₂H₄) into ethane (C₂H₆). A proposed mechanism for this chemical reaction, represented by

$${C}_{2} {H}_{4} + {H}_{2} \to {C}_{2} {H}_{6}$$

is

$${H}_{2} {⇄}_{{k}_{- 1}}^{{k}_{1}} 2 H$$

$${C}_{2} {H}_{4} + H {\to }^{{k}_{2}} {C}_{2} {H}_{5}$$

$${C}_{2} {H}_{5} + H {\to }^{{k}_{3}} {C}_{2} {H}_{6}$$

The problem is that of recovering the underlying chemical reaction network from snapshots of concentrations [H₂], [H], [C₂H₄] and [C₂H₅] and their time derivatives.

$$\frac{d [ {H}_{2} ]}{dt} , \frac{d [ H ]}{dt} , \frac{d [ {C}_{2} {H}_{4} ]}{dt} and \frac{d [ {C}_{2} {H}_{5} ]}{dt} .$$

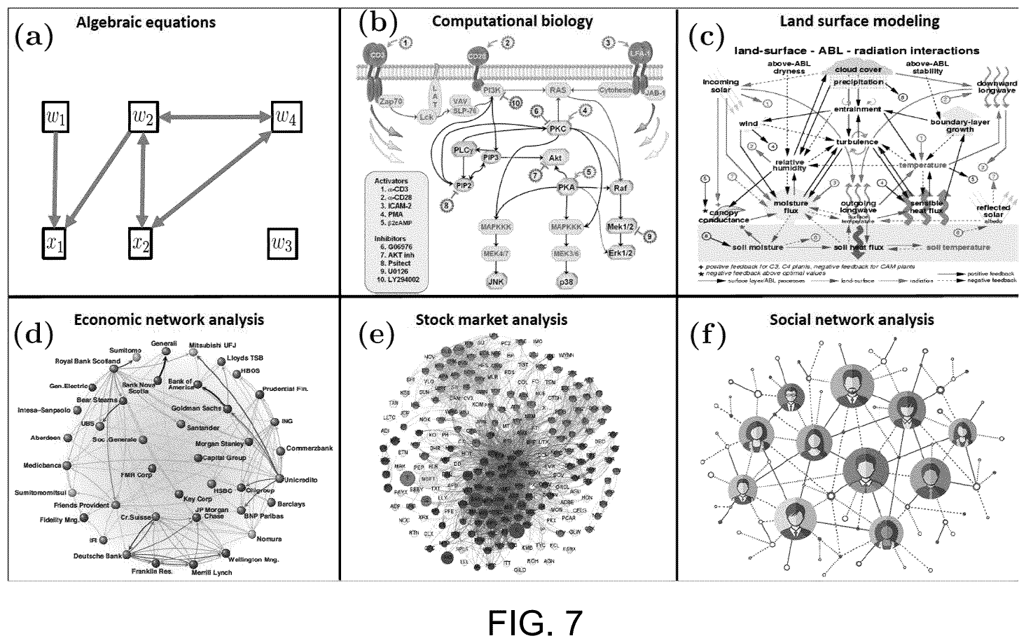

The proposed approach leads to a perfect recovery of the computational graph and a correct identification of quadratic functional dependencies between variables. A resultant computational graph of the recovery of a chemical reaction network is illustrated in FIG. 7.

Another problem is data analysis. As an example, consider the analysis of COVID-19 data from GOOGLE. Data from a single country, France, was used to ensure consistency in the data and to avoid considering cross-border variations that are not directly reflected in the data. Thirty one variables were selected that describe the state of the country during the pandemic, spanning over 500 data points, with each data point corresponding to a single day. These variables were categorized as the following datasets:
Epidemiology dataset: Includes quantities such as new infections, cumulative deaths, etc.
Hospital dataset: Provides information on the number of admitted patients, patients in intensive care, etc.
Vaccine dataset: Indicates the number of vaccinated individuals, etc.
Policy dataset: Consists of indicators related to government responses, such as school closures or lockdown measures, etc.

The problem is then to analyze this data and identify possible hidden functional relations between these variables.

Another problem is equation discovery. As an example, let w₁, w₂, w₃, w₄ and x₁, x₂ be six variables such that the wᵢ are i.i.d. [symbol] (0,1) random variables, and x₁, x₂ satisfy x₁=w₁w₂ and x₂=w₂ sin (w₄). Then, given N=1000 observations of (samples from) those variables, consider the problem of discovering hidden functional relationships or dependencies between these variables. (see FIG. 6(a)).

An open problem in computational biology is to identify pathways and interactions between genes from their expression levels. One example stems from phosphorylated proteins and phospholipids in the human immune system T-cells. This dataset consists of 11 proteins and N=7446 samples of their expressions. FIG. 6(b) presents the (reference) causal dependencies found using experiments and structure learning algorithms for Bayesian networks, i.e., the directed acyclic graph from the cell-signaling data.

Another example (see FIG. 6(c)) is the modeling of land surface interactions in weather prediction, and the problem is to discover possibly hidden functional dependencies between state variables for a finite number of snapshots of those variables.

Another example (see FIG. 6(d)) is the recovery and analysis of economic networks, and the problem is to discover functional dependencies between the economic markers of different agents or companies, which is significant to systemic risk analysis.

Another example (see FIG. 6(e)) concerns a graph analysis of the stock market, and the problem is to discover functional dependencies between the price returns of different stocks.

Another example (see FIG. 6(f)) is social network analysis/discovery, and the problem is to discover functional dependencies between quantitative markers associated with each individual (a vector of numbers per individual) in situations where the connectivity of the network may be hidden.

Another example is in autonomous vehicles, particularly in space. When vehicles are launched out into space, it can be difficult to train and account for the various situations that a vehicle may face. In addition, due to the distances, it can be difficult and slow to send additional information or to make adjustments to the vehicle. In several embodiments, vehicles may utilize hypergraph discovery to learn and adjust when current models are no longer accurate. By identifying new relationships between variables based on its new experiences, an autonomous vehicle may update its own programming and better adjust to unexpected environments.

### 3. Overview of the Proposed Approach for Type 3 Problems

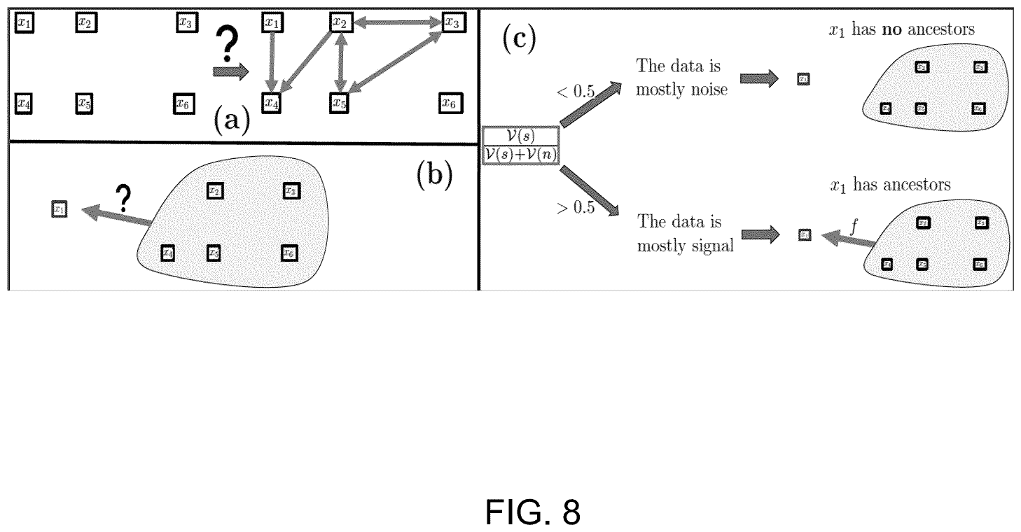

In this section, an overview of the proposed approach for Type 3 problems is presented. An example of a hypergraph discovery process in accordance with an embodiment of the invention is illustrated in FIG. 8. For ease of presentation, consider the simple setting of FIG. 8(a), given N samples on the variables x₁, . . . , x₆. After measurements/collection, these variables are normalized to have zero mean and unit variance. The objective is to uncover the underlying dependencies between them.
a. A signal-to-noise ratio to decide whether or not a node has ancestors.

Hypergraph discovery in accordance with certain embodiments of the invention identifies ancestors for each node in the graph. For a specific node, say x₁, as depicted in FIG. 8(b). Determining whether x₁ has ancestors is akin to asking if x₁ can be expressed as a function of x₂, x₃, . . . , x₆. In other words, can a function ƒ (living in a pre-specified space of functions that could be of controlled regularity) be found such that:

$${x}_{1} \approx f ( {x}_{2} , … , {x}_{6} ) ?$$

To answer this question, regress f with a centered GP ξ˜ [symbol] (0, Γ) whose covariance function Γ is an additive kernel of the form

$$Γ = {K}_{s} + γ δ ( x - y ) ,$$

where Kₛ is a smoothing kernel, γ>0 and δ(x−y) is the white noise covariance operator. This is equivalent to assuming the GP & to be the sum of two independent GPS, i.e., ξ=ξₛ+ξₙ where ξ˜ [symbol] (0, Kₛ) is a smoothing/signal GP and ξₙ˜ [symbol] (0, γδ(x−y) is a noise GP. Writing [symbol] _{K}_{ₛ} for the Reproducing Kernel Hilber Space (RKHS) induced by the kernel Kₛ, this is also equivalent to approximating f with a minimizer of

$${inf}_{f ∈ {ℋ}_{K}} {‖ f ‖}_{{K}_{s}}^{2} + \frac{1}{γ} {‖ f ( X ) - Y ‖}_{{ℝ}^{N}}^{2} ,$$

where [symbol] is the Euclidean norm on [symbol] , X is the input data on f obtained as an N-vector (or an N×M matrix) whose entries (or rows) Xᵢ are the samples on x₂, . . . , x₆, Y is the output data on f obtained as an N-vector whose entries are obtained from the samples on x₁, and f(X) is a N-vector whose entries are the evaluations f(Xᵢ). At the minimum

$$𝒱 ( s ) := {‖ f ‖}_{{K}_{s}}^{2}$$

quantifies the data variance explained by the signal GP ξₛ and

$$𝒱 ( n ) := \frac{1}{γ} {‖ f ( X ) - Y ‖}_{{ℝ}^{N}}^{2}$$

quantifies the data variance explained by the noise GP ξₙ. This allows us to define the signal-to-noise ratio

$$\frac{𝒱 ( s )}{𝒱 ( s ) + 𝒱 ( n )} ∈ [ 0 , 1 ] .$$

### If

$$\frac{𝒱 ( s )}{𝒱 ( s ) + 𝒱 ( n )} < 0.5 ,$$

then, as illustrated in FIG. 8(c), x₁ has no ancestors, i.e., x₁ cannot be approximated as a function of x₂, . . . , x₆. Conversely, if

$$\frac{𝒱 ( s )}{𝒱 ( s ) + 𝒱 ( n )} > 0.5 ,$$

then deduce that x₁ has ancestors, i.e., x₁ can be approximated as a function of x₂, . . . , x₆.

Although many of the examples described herein refer to a signal-to-noise (or noise-to-signal) ratio, one skilled in the art will recognize that these ratios maybe used interchangeably and/or other measures of functions can be used in a variety of applications without departing from this invention.

b. Selecting the Signal Kernel Kₛ.

In some embodiments, selecting the signal kernel is performed by selecting the kernel Kₛ to be linear (Kₛ(x,x′)=1+β₁Σᵢxᵢxᵢ′), quadratic (Kₛ(x,x′)=1+β₁Σᵢxᵢxᵢ′+β₂Σ_{i≤j}xᵢxⱼxᵢ′xⱼ′) or fully nonlinear (not linear and not quadratic) to identify f as linear, quadratic, or nonlinear. Hypergraph discovery processes in accordance with many embodiments of the invention may iterate through kernels in a specified order (e.g., linear, then quadratic, then nonlinear), in order to identify the simplest kernel that meets a threshold. Nonlinears may also be referred to as interpolatory as they may be selected as having an infinite-dimensional feature map. They may also be referred to as universal kernels. Kernels may also be referred to as interpolatory when the number of data points is smaller than the dimension of the feature map.

In the case of a nonlinear kernel, the following kernel may be employed:

$${K}_{s} ( x , {x}^{′} ) = 1 + {β}_{1} {\sum }_{i} {x}_{i} {x}_{i}^{′} + {β}_{2} {\sum }_{i \leq j} {x}_{i} {x}_{j} {x}_{i}^{′} {x}_{j}^{′} + {β}_{3} {\prod }_{i} ( 1 + k ( {x}_{i} , {x}_{i}^{′} ) ) \qquad ( 1 )$$

where k is a universal kernel, such as (but not limited to) a Gaussian or a Mátern kernel, with all parameters set to 1, and βᵢ assigned the default value 0.1. In some embodiments, Kₛ may be selected as the first kernel that surpasses a signal-to-noise ratio (e.g., 0.5). If no kernel reaches this threshold, it may be determined that x₁ lacks ancestors.
c. Pruning Ancestors Based on Signal-to-Noise Ratio.

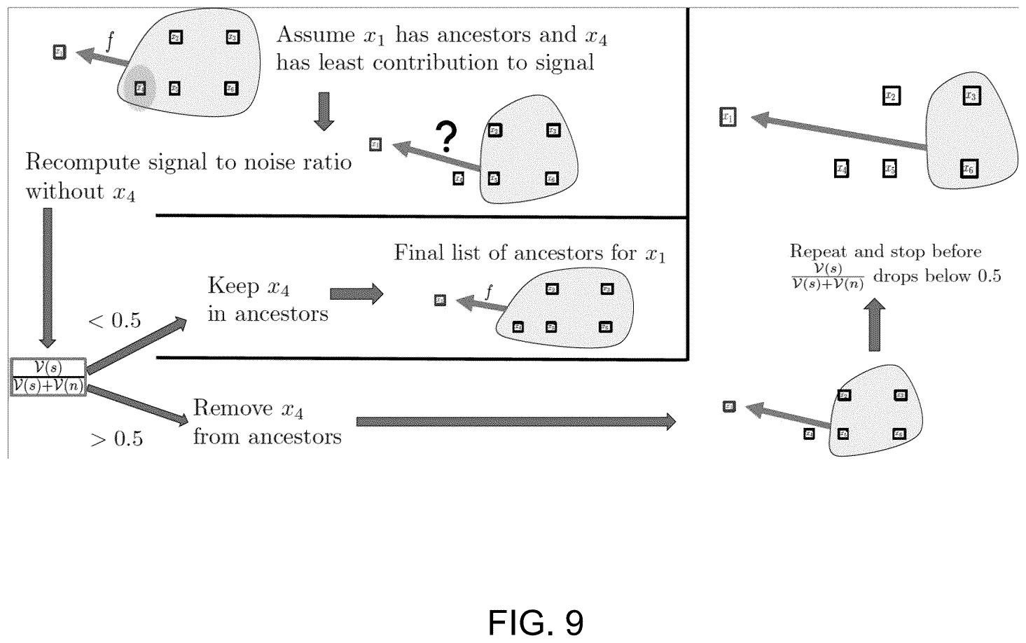

Once it is established that x₁ has ancestors (e.g., via kernel selection), its set of ancestors may be pruned iteratively in accordance with a variety of embodiments of the invention. An example of pruning ancestors in accordance with an embodiment of the invention is illustrated in FIG. 9. In numerous embodiments, nodes with the least contribution to the signal-to-noise ratio can be removed, stopping before that ratio drops below a threshold (e.g., 0.5). To describe this, assume that Kₛ is as in (Eq. 1). Then Kₛ is an additive kernel that can be decomposed into two parts:

$${K}_{s} = {K}_{1} + {K}_{2} ,$$

where

$${K}_{1} = 1 + {β}_{1} {\sum }_{i \neq 1 , 2} {x}_{i} {x}_{i}^{′} + {β}_{2} {\sum }_{i \leq j , i , j \neq 1 , 2} {x}_{i} {x}_{j} {x}_{i}^{′} {x}_{j}^{′} + {β}_{3} {\prod }_{i \neq 1 , 2} ( 1 + k ( {x}_{i} , {x}_{i}^{′} ) )$$

does not depend on x₂ and K₂=Kₛ−K₁ depends on x₂. This decomposition allows the expression of f as the sum of two components:

$$f = {f}_{1} + {f}_{2} ,$$

where f₁ does not depend on x₂, f₂ depends on x₂ and

$$( {f}_{1} , {f}_{2} ) = arg {min}_{( {g}_{1} , {g}_{2} ) ∈ {ℋ}_{{K}_{1}} \times {ℋ}_{{K}_{2}}} {‖ {g}_{1} ‖}_{{K}_{1}}^{2} + {‖ {g}_{2} ‖}_{{K}_{2}}^{2} .$$

Furthermore,

$${‖ f ‖}_{{K}_{s}}^{2} = {‖ {f}_{1} ‖}_{{K}_{1}}^{2} + {‖ {f}_{2} ‖}_{{K}_{2}}^{2} ,$$

and

$$\frac{{‖ {f}_{2} ‖}_{{K}_{1}}^{2}}{{‖ f ‖}_{{K}_{s}}^{2}} ∈ [ 0 , 1 ]$$

quantifies the contribution of x₂ to the signal data variance.

Following the procedure illustrated in FIG. 9, if, for example, x₄ is found to have the least contribution to the signal data variance, the signal-to-noise ratio can be recomputed without x₄ in the set of ancestors for x₁. If that ratio is below 0.5, x₄ is not removed from the list of ancestors, and x₂, x₃, x₄, x₅, x₆ is the final set of ancestors of x₁. If this ratio remains above 0.5, x₄ is removed. This iterative process continues, and stops before the signal-to-noise ratio drops below 0.5 to identify the final list of ancestors of x₁.

In a variety of embodiments, hypergraph discovery does not use a fixed threshold on the signal-to-noise ratio to prune ancestors, but rather employs an inflection point in the noise-to-signal ratio

$$\frac{𝒱 ( n )}{𝒱 ( s ) + 𝒱 ( n )} ( q )$$

as a function of the number q of ancestors. To put it simply, after ordering the ancestors in decreasing contribution to the signal, the final number q of ancestors is determined as the maximizer or

$$\frac{𝒱 ( n )}{𝒱 ( s ) + 𝒱 ( n )} ( q + 1 ) - \frac{𝒱 ( n )}{𝒱 ( s ) + 𝒱 ( n )} ( q ) .$$

### 4. Hypergraph Discovery

In this section, an accessible overview of key components of hypergraph discovery in accordance with numerous embodiments of the invention is discussed. Processes in accordance with a variety of embodiments of the invention focus on determining the edges within a hypergraph. To achieve this, processes in accordance with certain embodiments of the invention consider each node individually, find its ancestors, and establish edges from these ancestors to the node in question. While processes are described throughout this specification are often described for a single node, one skilled in the art will recognize that processes can be applied iteratively to all nodes within the graph. Processes in accordance with a number of embodiments of the invention include:

1. Initialization: Assume that all other nodes are potential ancestors of the current node.

2. Selecting a Kernel: Choose a kernel function, such as linear, quadratic, or fully nonlinear kernels (refer to Example 1). The kernel selection process is analogous to the subsequent pruning steps, involving the determination of a parameter γ, regression analysis, and evaluation based on signal-to-noise ratios. In various embodiments, if the signal-to-noise ratio is insufficient for all possible kernels, the process terminates, indicating that the node has no ancestors.

3. Pruning Process: While there are potential ancestors left to consider:
(a) Identify the Least Important Ancestor: Ancestors are ranked based on their contribution to the signal.
(b) Noise prior: Determine the value of γ.
(c) Regression Analysis: Predict the node's value using the current set of ancestors, excluding the least active one (i.e., the one contributing the least to the signal). Processes in accordance with several embodiments of the invention employ Kernel Ridge Regression with the selected kernel function and parameter γ.
(d) Evaluate Removal: Compute the regression signal-to-noise ratio. If the signal-to-noise ratio falls below a certain threshold, terminate the process and return the current set of ancestors. If the signal-to-noise ratio is sufficient, remove the least active ancestor and continue the pruning process.

Throughout this description, processes in accordance with several embodiments of the invention may be further refined and generalized, as discussed in the following subsections.

Complexity Reduction with Kernel PCA Variant. To improve efficiency, processes in accordance with various embodiments of the invention introduce a variant of Kernel PCA. This modification significantly reduces the computational complexity of hypergraph discovery, making it primarily dependent on the number of principal nonlinear components in the underlying kernel matrices rather than the number of data points.

Generalizing Descendants and Ancestors with Kernel Mode Decomposition. In several embodiments, the concept of descendants and ancestors can be extended to cover more complex functional dependencies between variables, including implicit ones, as discussed in greater detail below. This generalization can be achieved through a Kernel-based adaptation of Row Echelon Form Reduction, initially designed for affine systems, and leveraging the principles of Kernel Mode Decomposition.

Parameter Selection. The choice of the parameter γ can be a critical aspect of hypergraph discovery. Processes in accordance with a number of embodiments of the invention provide a structured approach for selecting γ based on the characteristics of the kernel matrix Kₛ. Specifically, when Kₛ is derived from a finite-dimensional feature map ψ, the regression residual can be employed to determine γ as follows: γ=minᵥ∥v^{T}ψ(X)−Y [symbol] as discussed below. Alternatively, when Kₛ is a universal kernel, γ can be selected by maximizing the variance of the eigenvalue histogram of γ(Kₛ(X,X)+γI)⁻¹, as discussed in greater detail below.

Ancestor pruning. Hypergraph discovery in accordance with certain embodiments of the invention does not use a fixed threshold on the signal-to-noise ratio to prune ancestors, but rather employs an inflection point in the noise-to-signal ratio

$$\frac{𝒱 ( n )}{𝒱 ( s ) + 𝒱 ( n )} ( q )$$

as a function of the number q of ancestors. To put it simply, after ordering the ancestors in decreasing contribution to the signal, the final number q of ancestors is determined as the maximizer of

$$\frac{𝒱 ( n )}{𝒱 ( s ) + 𝒱 ( n )} ( q + 1 ) - \frac{𝒱 ( n )}{𝒱 ( s ) + 𝒱 ( n )} ( q ) .$$

An example of hypergraph discovery processes in accordance with numerous embodiments of the invention is illustrated with an application to the recovery of a mechanical network. The Fermi-Pasta-Ulam-Tsingou (FPUT) system is a prototypical chaotic dynamical system. It is composed of a set of M masses indexed by j∈{0, . . . , M−1} with equilibrium position jh with h=1/M. Each mass is tethered to its two adjacent masses by a nonlinear spring, and the displacement of the mass x; adheres to the equation:

$${\ddot{x}}_{j} = \frac{{c}^{2}}{{h}^{2}} ( {x}_{j + 1} + {x}_{j - 1} - 2 {x}_{j} ) ( 1 + α ( {x}_{j + 1} - {x}_{j - 1} ) )$$

where c² is a velocity depending on h and the strength of the springs, c=1, and M=10. Fixed boundary conditions can be used by adding two more masses, with x₋₁=x_{M}=0.

The selection of this model is driven by several aspects: its chaotic behavior, established and sparse equations, and the presence of linear/nonlinear equations contingent on the choice of a. The system can be simulated with two different choices of α: a nonlinear case where α(x)=x², and a linear case where α(x)=0.

A total of 1000 snapshots were taken from multiple trajectories and the observed variables are the positions, velocities, and accelerations of all the underlying masses. In the graph discovery phase, every other node is initially deemed a potential ancestor for a specified node of interest. The node with the least signal contribution was then iteratively removed. The step resulting in the largest surge in the noise-to-signal ratio is inferred as one eliminating a crucial ancestor, thereby pinpointing the final ancestor set.

An example of noise-to-signal ratio

$$\frac{𝒱 ( n )}{𝒱 ( s ) + 𝒱 ( n )} ( q )$$

as a function of the number q of proposed ancestors and noise-to-signal ratio increments

$$\frac{𝒱 ( n )}{𝒱 ( s ) + 𝒱 ( n )} ( q ) - \frac{𝒱 ( n )}{𝒱 ( s ) + 𝒱 ( n )} ( q - 1 )$$

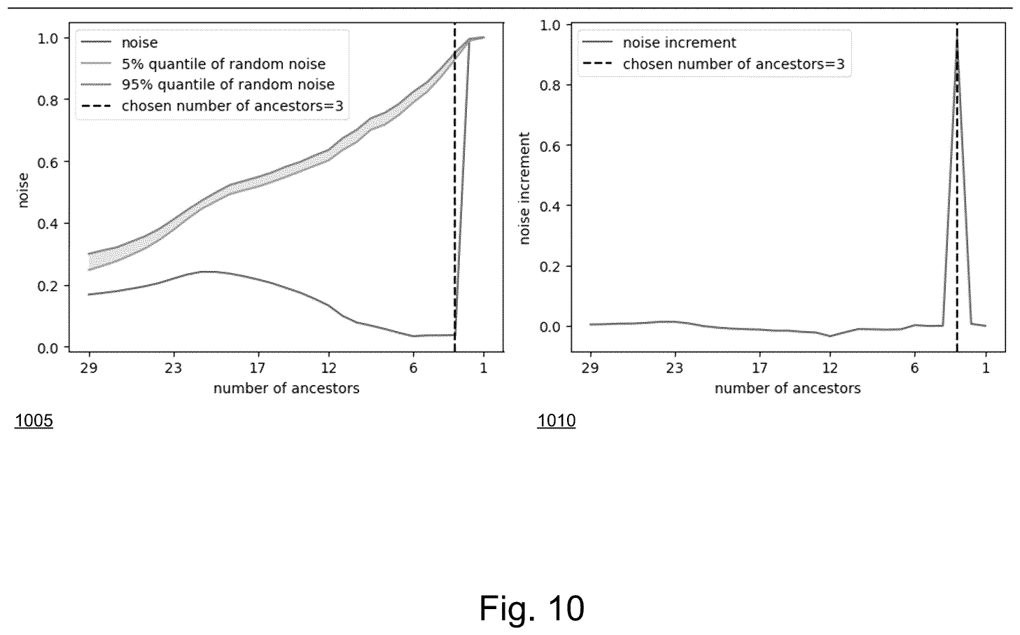

as a function of the number q of ancestors in accordance with an embodiment of the invention are illustrated in FIG. 10. Z-test quantiles are also plotted in chart 1005. In the absence of signal, the noise-to-signal ratio should fall within the shaded area with probability 0.9. FIG. 10 includes chart 1005, which shows a plot of the noise-to-signal ratio

$$\frac{𝒱 ( n )}{𝒱 ( s ) + 𝒱 ( n )} ( q )$$

as a function of the number q of proposed ancestors for the variable \ddot{x}₇ and with Z-test quantiles (in the absence of signal, the noise-to-signal ratio should fall within the shaded area with probability 0.9). Removing a node essential to the equation of interest causes the noise-to-signal ratio to markedly jump from approximately 25% to 99%. Chart 1010 shows a plot of the noise-to-signal ratio increments

$$\frac{𝒱 ( n )}{𝒱 ( s ) + 𝒱 ( n )} ( q ) - \frac{𝒱 ( n )}{𝒱 ( s ) + 𝒱 ( n )} ( q - 1 )$$

as a function of the number q of ancestors for the variable \ddot{x}₇. Note that the increase in the noise-to-signal ratio is significantly higher compared to previous removals when an essential node was removed. Therefore, while solely relying on a fixed threshold to decide when to cease the removals might prove challenging, evaluating the increments in noise-to-signal ratios can offer a clear guideline for efficiently and reliably pruning ancestors.

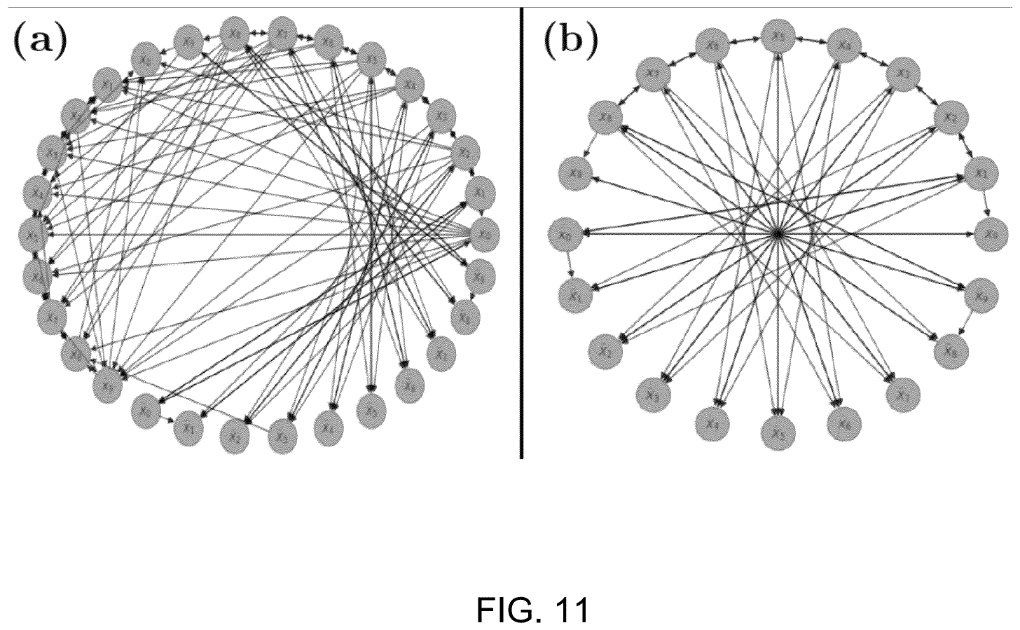

An example of result data from an analysis of a FPUT system is illustrated in FIG. 11. The recovered full graph, depicted in FIG. 11(a), is remarkably accurate despite the nonlinear nature of the model and the fact that the prior only encodes that the nonlinearity is smooth. Therefore, hypergraph discovery in accordance with some embodiments of the invention does not require a dictionary or extensive knowledge of the structure of the unknown functions. Notably, velocity variables are accurately identified as non-essential and omitted from the ancestors of position and acceleration variables. FIG. 11(b), which omits velocity variables for clarity, further elucidates the accurate recovery of dependencies. The dependencies are the simplest and clearest possible. They match exactly those of the original equations except for the boundary particles for which valid equivalent equations are recovered.

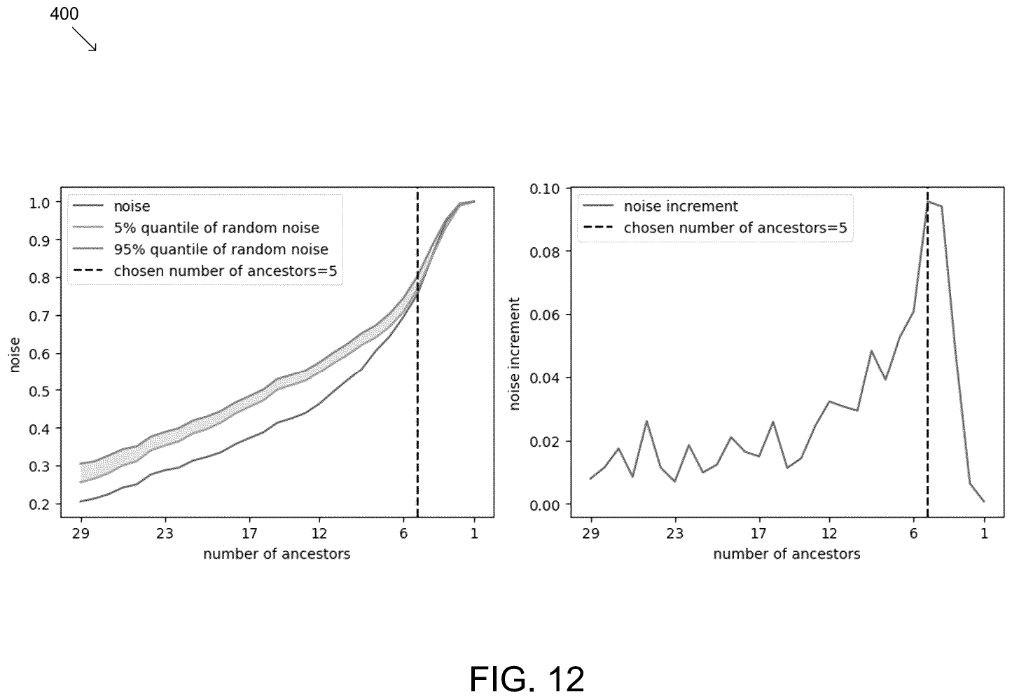

While performing these experiments, a set threshold of 60% on the noise-to-signal ratio could be used to obtain the desired equations. However, this choice could be seen as arbitrary or guided by knowledge of the true equations. However, the choice to retain or discard an ancestor becomes clear when examining the noise-to-signal ratio's evolution against the number of ancestors. In the graph discovery phase, every other node is initially deemed a potential ancestor for a specified node of interest. The node with the least signal contribution is then iteratively removed. The step resulting in the largest surge in the noise-to-signal ratio is inferred as one eliminating a crucial ancestor, thereby pinpointing the final ancestor set. In the context of the FPUT problem, removing a node essential to the equation of interest causes the noise-to-signal ratio to markedly jump from approximately 25% to 99%. Additionally, the increase in the noise-to-signal ratio during the removal process can be analyzed. Two representative trajectories illustrating this are presented in FIGS. 10 and 12. Notably, in the final iteration where an essential node was removed, the increase in the noise-to-signal ratio is significantly higher compared to previous removals. This observation indicates that the process halted at the appropriate juncture, as the removal of this last node was not sanctioned. As shown in FIG. 12, while solely relying on a fixed threshold to decide when to cease the removals might prove challenging, evaluating the increments in noise-to-signal ratios offers a clear guideline for efficiently and reliably pruning ancestors.

Type 3 problems are challenging and can even be intractable if not formalized and approached properly. First, the problem suffers from the curse of combinatorial complexity in the sense that the number of hypergraphs associated with N nodes blows up rapidly with N. A lower bound on the number of hypergraphs associated with 3 nodes is the A003180 sequence, which answers the following question: given N unlabeled vertices, how many different hypergraphs in total can be realized on them by counting the equivalent hypergraphs only once? For N=8, this lower bound is ≈2.78×10⁷³.

Secondly, it is important to note that, even with an infinite amount of data, the exact structure of the hypergraph might not be identifiable. To illustrate this point, consider a problem with N samples from a computational graph with variables x and y. The task is to determine the direction of functional dependency between x and y. Does the dependency go from x to y or from y to x? In some cases, it may be clear when y can only be expressed as a function of x or when x can solely be written as a function of y. However, in some situations, it becomes challenging to decide as it may be possible to write both y as a function of x and x as a function of y. Further complicating matters is the possibility of implicit dependencies between variables. There may also be instances where neither y can be derived as a function of x, nor x can be represented as a function of y.

The field of causal inference and probabilistic modeling seeks to address distinct graph learning problems by introducing auxiliary assumptions. Within noise and probabilistic models, it is generally assumed that the data is randomized.

Causal inference methods broadly consist of two approaches: constraint and score-based methods. While constraint-based approaches are asymptotically consistent, they only learn the graph up to an equivalence class. Instead, score-based methods resolve ambiguities in the graph's edges by evaluating the likelihood of the observed data for each graphical model. For instance, they may assign a higher evidence to y→x over x→y if the conditional distribution x|y exhibits less complexity than y|x. The complexity of searching over all possible graphs, however, grows super-exponentially with the number of variables. Thus, it is often necessary to use approximate, but more tractable, search-based methods or alternative criteria based on sensitivity analysis. For example, the preference could lean towards y→x rather than x→y if y demonstrates less sensitivity to errors or perturbations in x. In contrast, processes in accordance with several embodiments of the invention avoid the growth in complexity by performing a guided pruning process that assesses the contribution of each node to the signal. Hypergraph discovery in accordance with numerous embodiments of the invention is not limited to learning acyclic graph structures as it can identify feedback loops between variables.

Alternatively, methods for learning probabilistic undirected graphical models, also known as Markov networks, identify the graph structure by assuming the data is randomly drawn from some probability distribution. In this case, edges in the graph (or lack thereof) encode conditional dependencies between the nodes. A common approach learns the graph structure by modeling the data as being drawn from a multivariate Gaussian distribution with a sparse inverse covariance matrix, whose zero entries indicate pairwise conditional independencies. Recently, this approach has been extended using models for non-Gaussian distributions, as well as kernel-based conditional independence tests. In a variety of embodiments, functional dependencies are learned rather than causality or probabilistic dependence. It is not assumed that the data is randomized nor are strong assumptions imposed, such as additive noise models, in the data-generating process.

Compare the hypergraph discovery framework to structure learning for Bayesian networks and structural equation models (SEM). Let x∈ [symbol] be a random variable with probability density function p that follows the autoregressive factorization p(x)=Πᵢ₌₁^{d}pᵢ(xᵢ|x₁, . . . , xᵢ₋₁) given a prescribed variable ordering. Structure learning for Bayesian networks aims to find the ancestors of variable xᵢ, often referred to as the set of parents Pa(i)⊆{1, . . . , i−1}, in the sense that pᵢ(xᵢ|x₁, . . . , xᵢ₋₁)=pᵢ(xᵢ|x_{Pa(i)}). Thus, the variable dependence of the conditional density pᵢ is identified by finding the parent set so that xᵢ is conditionally independent of all remaining preceding variables given its parents, i.e., xᵢ⊥x_{1:i-1\Pa(i)}|x_{Pa(i)}. Finding ancestors that satisfy this condition requires performing conditional independence tests, which are computationally expensive for general distributions. Alternatively, SEMs assume that each variable xᵢ is drawn as a function of its ancestors with additive noise, i.e, xᵢ=f(x_{Pa(i)})+ϵᵢ for some function ƒ and noise ϵ. For Gaussian noise ϵᵢ˜ [symbol] (0, σ²), each marginal conditional distribution in a Bayesian network is given by

$${p}_{i} ( {x}_{i} \vert {x}_{1 : i - 1} ) ∝ exp ( - \frac{1}{2 {σ}^{2}} {‖ {x}_{i} - f ( {x}_{1 : i - 1} ) ‖}^{2} ) .$$

Thus, finding the parents for such a model by maximum likelihood estimation corresponds to finding the parents that minimize the expected mean-squared error ∥x₁−f(x_{Pa(i)})∥². While the graph structure identified in Bayesian networks is influenced by the specific sequence in which variables are arranged (a concept exploited in numerical linear algebra where Schur complementation is equivalent to conditioning GPs and a carefully ordering leads to the accuracy of the Vecchia approximation pᵢ(xᵢ|x₁, . . . , xᵢ₋₁)≈pᵢ(xᵢ|xᵢ₋ₖ, . . . , xᵢ₋₁)), the graph recovered by hypergraph discovery in accordance with various embodiments of the invention remains unaffected by any predetermined ordering of those variables.

In a number of embodiments, a formulation of the problem is used that remains well-posed even when the data is not randomized, i.e., the problem can be formulated as the following manifold learning/discovery problem.

Problem 1 Let [symbol] be a Reproducing Kernel Hilbert Space (RKHS) of functions mapping [symbol] to [symbol] . Let [symbol] be a closed linear subspace of [symbol] and let [symbol] be a subset of [symbol] such that x∈ [symbol] if and only if f(x)=0 for all f∈ [symbol] .

Given the (possibly noisy and nonrandom) observation of N elements, X₁, . . . , X_{N}, of [symbol] approximate [symbol] . To understand why problem 1 serves as the appropriate formulation for hypergraph discovery, consider a manifold [symbol] ⊂ [symbol] . Suppose this manifold can be represented by a set of equations, expressed as a collection of functions (fₖ)ₖ satisfying ∀x∈ [symbol] , fₖ(x)=0. To keep the problem tractable, assume a certain level of regularity for these functions, necessitating they belong to a RKHS [symbol] , ensuring the applicability of kernel methods for our framework. Given that any linear combination of the fₖ will also be evaluated to zero on M, the relevant functions are those within the span of the fₖ, forming a closed linear subspace of [symbol] denoted as [symbol] .

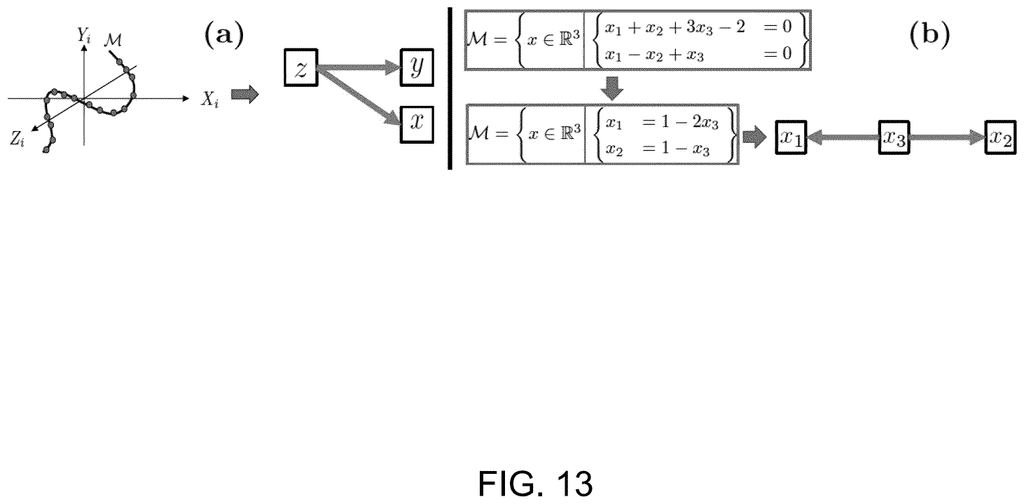

An example of (a) hyper formulation as a manifold discovery problem and hypergraph representation (b) the hypergraph representation of an affine manifold is equivalent to its Row Echelon Form Reduction in accordance with an embodiment of the invention is illustrated in FIG. 13. The manifold M can be subsequently represented by a graph or hypergraph (see FIG. 13(a)), whose ambiguity can be resolved through a deliberate decision to classify some variables as free and others as dependent. This selection could be arbitrary, informed by expert knowledge, and/or derived from probabilistic models or sensitivity analysis.

Systems and methods in accordance with some embodiments of the invention include a kernel generalization of variance-based sensitivity analysis guiding the discovery of the structure of the hypergraph. In a variety of embodiments, GP variance decomposition of the data leads to signal-to-noise and a Z-score that can be employed to determine whether a given variable can be approximated as a nonlinear function of a given number of other variables.

To describe the proposed solution to Problem 1, start with a simple example. In this example, [symbol] is a space of affine functions ƒ of the form

$$f ( x ) = {v}^{T} ψ ( x ) with ψ ( x ) := ( \begin{matrix}1 \\ x\end{matrix} ) and v ∈ {ℝ}^{d + 1} , .$$

As a particular instantiation (see FIG. 13(b)), assume [symbol] to be the manifold of [symbol] (d=3) defined by the affine equations

$$ℳ = \{ x ∈ {ℝ}^{3} \vert \{ \begin{matrix}{x}_{1} + {x}_{2} + 3 {x}_{3} - 2 & = 0 \\ {x}_{1} - {x}_{2} + {x}_{3} & = 0\end{matrix} \} , \qquad ( 2 )$$

which is equivalent to selecting [symbol] =span{f₁, f₂} with f₁(x)=x₁+x₂+3x₃−2 and f₂(x)=x₁−x₂+x₃ in the problem formulation 1.

Then, irrespective of how the manifold is recovered from data, the hypergraph representation of that manifold is equivalent to the row echelon form reduction of the affine system, and this representation and this reduction require a possibly arbitrary choice of free and dependent variables. So, for instance, for the system (Eq. 2), if x₃ is declared to be the free variables and x₁ and x₂ to be the dependent variables, then the manifold can be represented via the equations

$$ℳ = \{ x ∈ {ℝ}^{3} \vert \{ \begin{matrix}{x}_{1} & = 1 - 2 {x}_{3} \\ {x}_{2} & = 1 - {x}_{3}\end{matrix} \} ,$$

which have the hypergraph representation depicted in FIG. 13(b).

Now, in the N>d regime where the number of data points is larger than the number of variables, the manifold can simply be approximated via a variant of PCA in accordance with many embodiments of the invention. Take f*∈ [symbol] , f*(x)=v*^{T}ψ(x) for a certain v*∈ [symbol] . Then for Xₛ∈ [symbol] , f*(Xₛ)=ψ(Xₛ)^{T}v*=0. Defining

$${C}_{N} := {\sum }_{s = 1}^{N} ψ ( {X}_{s} ) {ψ ( {X}_{s} )}^{T} \qquad ( 3 )$$

f*(Xₛ)=0 for all Xₛ is equivalent to C_{N}v*=0. Since N>d, [symbol] can be identified exactly as {v^{T}ψ for v∈Ker(C_{N})}. Then the obtained manifold is

$${ℳ}_{N} = \{ x ∈ {ℝ}^{d} \vert {v}^{T} ψ ( x ) = 0 for v ∈ Span ( {v}_{r + 1} , … , {v}_{d + 1} ) \} \qquad ( 4 )$$

where Span (vᵣ₊₁, . . . , v_{d+1}) is the zero-eigenspace of C_{N}. λ₁≥ . . . ≥λᵣ>0=λᵣ₊₁= . . . =λ_{d+1} can be written for the eigenvalues of C_{N} (in decreasing order), and v₁, . . . , v_{d+1} for the corresponding eigenvectors (C_{N}vᵢ=λᵢvᵢ). Hypergraph discovery in accordance with a number of embodiments of the invention extends to the noisy case (when the data points are perturbations of elements of the manifold) by simply replacing the zero-eigenspace of the covariance matrix by the linear span of the eigenvectors associated with eigenvalues that are smaller than some threshold α>0, i.e., by approximating M with (Eq. 4) where r is such that λ₁≥ . . . ≥λᵣ≥ϵ>λᵣ₊₁≥ . . . ≥λ_{d+1}. In this affine setting, (Eq. 4) allows the estimation of M directly without RKHS norm minimization/regularization because linear regression does not require regularization in the sufficiently large data regime. Furthermore, in some embodiments, the process of pruning ancestors can be replaced by that of identifying sparse elements v∈Span(vᵣ₊₁, . . . , v_{d+1}) such that vᵢ=1.

This simple approach can be generalized in accordance with numerous embodiments of the invention by generalizing the underlying feature map ψ used to define the space of functions (writing dₛ for the dimension of the range of ψ)

$$ℋ = \{ f ( x ) = {v}^{T} ψ ( x ) \vert v ∈ {ℝ}^{{d}_{s}} \}$$

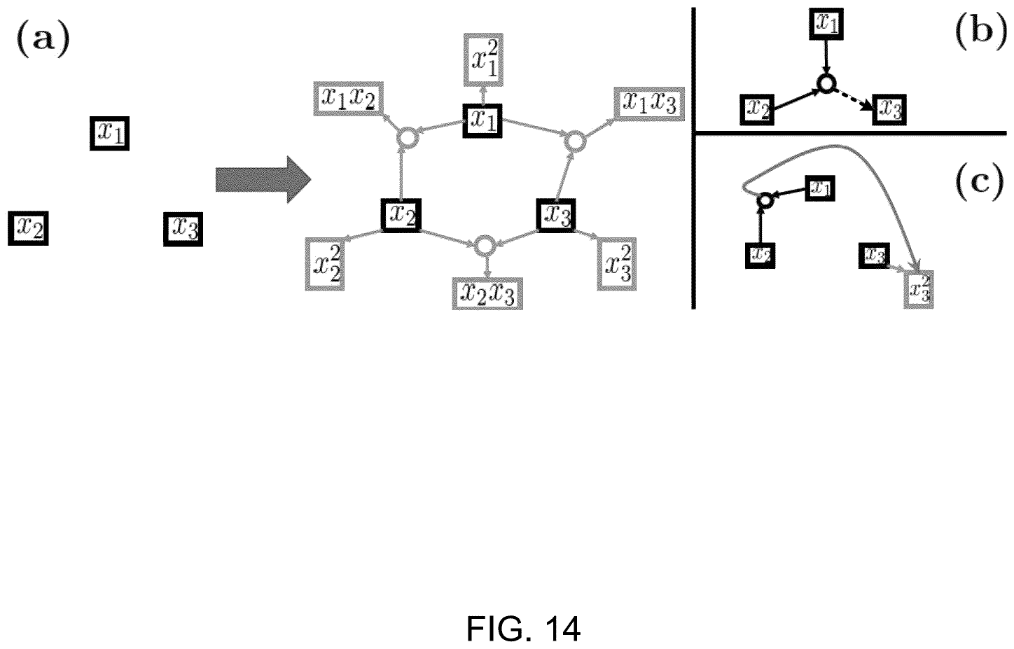

An example of feature map generalization in accordance with an embodiment of the invention is illustrated in FIG. 14.

For instance, using the feature map

$$ψ ( x ) := {( 1 , … , {x}_{i} , … , {x}_{i} {x}_{j} , … )}^{T} \qquad ( 5 )$$

then [symbol] becomes a space of quadratic polynomials on [symbol] , i.e.,

$$ℋ = \{ f ( x ) = {v}_{0} + {\sum }_{i} {v}_{i} {x}_{i} + {\sum }_{i \leq j} {v}_{i , j} {x}_{i} {x}_{j} \vert v ∈ {ℝ}^{{d}_{s}} \} ,$$

and, in the large data regime (N>dₛ), identifying quadratic dependencies between variables becomes equivalent to (1) adding nodes to the hypergraph corresponding to secondary variables obtained from primary variables xᵢxⱼ through known functions (for (Eq. 5), these secondary variables are the quadratic monomials xᵢxⱼ, see FIG. 14(a)), and (2) identifying affine dependencies between the variables of the augmented hypergraph. The problem can, therefore, be reduced to the affine case. Indeed, as in the affine case, the manifold can then be approximated in the regime where the number of data points is larger than the dimension dₛ of the feature map by (Eq. 4), where vᵣ, . . . , v_{N} are the eigenvectors of C_{N}=(Eq. 3) whose eigenvalues are zero (noiseless case) or smaller than some threshold ϵ>0 (noisy case).

Furthermore, the hypergraph representation of the manifold is equivalent to a feature map generalization of Row Echelon Form Reduction to nonlinear systems of equations. For instance, choosing x₃ as the dependent variable and x₁, x₂ as the free variables, [symbol] ={x∈ [symbol] |x₃−5x₁²+x₂²−x₁x₂=0} can be represented as in FIG. 14(b) where the round node represents the concatenated variable (x₁, x₂) and the dashed arrow represents a quadratic function. In several embodiments, the generalization also enables the representation of implicit equations by selecting secondary variables as free variables. For instance, selecting x₃² as the free variable and x₁, x₂ as the free variables, [symbol] ={x∈ [symbol] |x₁²+x₂²+x₃²−1=0} can be represented as in FIG. 14(c).

This feature-map extension of the affine case can evidently be generalized to arbitrary degree polynomials and to other basis functions. However, as the dimension dₛ of the range of the feature map ψ increases beyond the number N of data points, the problem becomes underdetermined: the data only provides partial information about the manifold, i.e., it is not sufficient to uniquely determine the manifold. Furthermore, if the dimension of the feature map is infinite, then the problem is always in that low data regime, and there is the additional difficulty that we cannot directly compute with that feature map. On the other hand, if dₛ is finite (i.e., if the dictionary of basis functions is finite), then some elements of [symbol] (some constraints defining the manifold [symbol] ) may not be representable or well approximated as equations of the form v^{T}ψ(x)=0. To address these conflicting requirements, processes in accordance with numerous embodiments of the invention may be kernelized and/or regularized (as done in interpolation).

The kernel associated with the feature map. To describe this kernelization, assume that the feature map ψ maps [symbol] to some Hilbert space [symbol] that could be infinite-dimensional, and write K for the kernel defined by that feature map. To be precise, consider the setting where the feature map ψ is a function from [symbol] to a (possibly infinite-dimensional separable) Hilbert (feature) space [symbol] endowed with the inner product [symbol] ·,· [symbol] . To simplify notations, write v^{T}w for [symbol] v, w [symbol] s and vw^{T} for the linear operator mapping v′ to v [symbol] w, v′ [symbol] s. Let

$$ℋ := \{ {v}^{T} ψ ( x ) \vert v ∈ 𝒮 \}$$

be the space of functions mapping [symbol] to [symbol] defined by the feature map ψ. To avoid ambiguity, assume (without loss of generality) that the identity v^{T}ψ(x)=w^{T}ψ(x) holds for all x∈ [symbol] if and only if v=w. It follows that for f∈ [symbol] there exists a unique v∈ [symbol] such that f=v^{T}ψ. For f, g∈ [symbol] with f=v^{T}ψ and g=w^{T}ψ, define

$${〈 f , g 〉}_{ℋ} := {v}^{T} w .$$

Observe that [symbol] is a Hilbert space endowed with the inner product [symbol] ·,· [symbol] . For x, x′∈ [symbol] , write

$$K ( x , {x}^{′} ) := {ψ ( x )}^{T} ψ ( {x}^{′} ) ,$$

for the kernel defined by w and observe that ( [symbol] , [symbol] ·,· [symbol] ) is the RKHS defined by the kernel K (which is assumed to contain [symbol] in Problem 1). Observe in particular that for f=v^{T}ψ∈ [symbol] , K satisfies the reproducing property

$${〈 f , K ( x , \cdot ) 〉}_{ℋ} = {v}^{T} ψ ( x ) = f ( x ) . \qquad ( 6 )$$

Complexity Reduction with Kernel PCA Variant. In some embodiments, the feature-map PCA variant (characterizing the subspace of f∈ [symbol] such that f(X)=0) can be kernelized as a variant of kernel PCA. To describe this, write K(X,X) for the N×N matrix with entries K(Xᵢ, Xⱼ). Write λ₁≥λ₂≥ . . . ≥λᵣ>0 for the nonzero eigenvalues of K(X,X) indexed in decreasing order and write α._{,i} for the corresponding unit-normalized eigenvectors, i.e.

$$K ( X , X ) {α}_{\cdot , i} = {λ}_{i} {α}_{\cdot , i} and \vert {α}_{\cdot , i} \vert = 1.$$

Write f(X) for the N vector with entries f(Xₛ). For i≤r, write

$${ϕ}_{i} := {\sum }_{s = 1}^{N} {δ}_{{X}_{s}} {α}_{s , i} \\ and \\ f ( {ϕ}_{i} ) := {\sum }_{s = 1}^{N} f ( {X}_{s} ) {α}_{s , i} .$$

Write f(ϕ) for the r vector with entries f(ϕᵢ).

Proposition 6.1 The subspace of functions ƒ∈ [symbol] such that f(ϕ)=0 is equal to the subspace of f∈ [symbol] such that f(X)=0. Furthermore, for f∈ [symbol] with feature map representation f=v^{T}ψ with v∈ [symbol] we have the identity (where C_{N}=(Eq. 3))

$${v}^{T} {C}_{N} v = {\vert f ( ϕ ) \vert}^{2} = {\vert f ( X ) \vert}^{2} . \qquad ( 7 )$$

Proof. Write \hat{λ}₁≥\hat{λ}₂≥ . . . ≥\hat{λ}ᵣ>0 for the nonzero eigenvalues of C_{N}=(Eq. 3) indexed in decreasing order. Write v₁, . . . , vᵣ for the corresponding eigenvectors, i.e.,

$${C}_{N} {v}_{i} = {\hat{λ}}_{i} {v}_{i} . \qquad ( 8 )$$

Observing that

$${C}_{N} = {\sum }_{i = 1}^{r} {\hat{λ}}_{i} {v}_{i} {v}_{i}^{T}$$

deduce that the zero-eigenspace of C_{N} is the set of vectors v∈ [symbol] such that v^{T}vᵢ=0 for i=1, . . . , r. Write fᵢ:=vᵢ^{T}ψ. Observe that for f=v^{T}ψ, vᵢ^{T}v= [symbol] fᵢ,f [symbol] . Multiplying (Eq. 8) by ψ^{T}(x) implies

$${\sum }_{s = 1}^{N} K ( x , {X}_{s} ) {f}_{i} ( {X}_{s} ) = {\hat{λ}}_{i} {f}_{i} ( x ) \qquad ( 9 )$$

(Eq. 9) implies that for f=v^{T}ψ

$${v}_{i}^{T} v = {\sum }_{s = 1}^{N} {λ}_{i}^{- 1} {f}_{i} ( {X}_{s} ) {〈 K ( \cdot , {X}_{s} ) f 〉}_{K} = {\sum }_{s = 1}^{N} {λ}_{i}^{- 1} {f}_{i} ( {X}_{s} ) f ( {X}_{s} ) \qquad ( 10 )$$

using the reproducing property (Eq. 6) of K in the last identity. Write

$${\hat{α}}_{s , i} := {λ}_{i}^{- \frac{1}{2}} {f}_{i} ( {X}_{s} ) . \qquad ( 11 )$$

Using (Eq. 9) with x=Xₛ, implies that \hat{α}._{,i} is an eigenvector of the N×N matrix K(X,X) with eigenvalue \hat{λ}ᵢ. Taking f=fᵢ in (Eq. 10) implies that 1=vᵢ^{T}vᵢ=|\hat{α}._{,i}|². Therefore, the \hat{α}._{,i} are unit-normalized. Summarizing, this analysis (closely related to the one found in kernel PCA) shows that the nonzero eigenvalues of K(X,X) coincide with those of C_{N} and \hat{r}=r, \hat{λ}ᵢ=λᵢ and \hat{α}._{,i}=α._{,i}. Furthermore, (Eq. 10) and (Eq. 11) imply that for i≤r, v∈ [symbol] and f=v^{T}ψ,

$${v}_{i}^{T} v = {λ}_{i}^{- \frac{1}{2}} f ( X ) {α}_{. , i} . \qquad ( 12 )$$

The identity (Eq. 12) then implies (Eq. 7).

Remark As in PCA the dimension/complexity of the problem can be further reduced by truncating ϕ to ϕ′=(ϕ₁, . . . , ϕᵣ,) where r′≤r is identified as the smallest index i such that λᵢ/λ₁<ϵ where ϵ>0 is some small threshold.

Kernel Mode Decomposition. When the feature map w is infinite-dimensional, the data only provides partial information about the constraints defining the manifold in the sense that f(X)=0 or equivalently f(ϕ)=0 is a necessary, but not sufficient, condition for the zero level set of f to be a valid constraint for the manifold (for f to be such that f(x)=0 for all x∈ [symbol] ). This leads to the following problems: (1) How to regularize? (2) How to identify free and dependent variables? (3) How to identify valid constraints for the manifold? In some embodiments, in order to address such problems, hypergraph discovery may be based on the Kernel Mode Decomposition (KMD) framework.

A quick reminder on KMD in the setting of the following mode decomposition problem. So, in this problem, an unknown function ƒ^{†} maps some input space [symbol] to the real line [symbol] . This function can be written as a sum of m other unknown functions ƒ^{†} (or modes), i.e.,

$${f}^{†} = {\sum }_{i = 1}^{m} {f}_{i}^{†} .$$

Assume each mode fᵢ^{†} to be an unknown element of some RKHS [symbol] _{K}_{ᵢ} defined by some kernel Kᵢ. Then consider the problem in which given the data f^{†}(X)=Y (with (X,Y)∈ [symbol] × [symbol] ), the m modes composing the target function ƒ^{†} are to be approximate.

Theorem 6.3 Using the relative error in the product norm ∥(f₁, . . . , fₘ)∥²:=Σᵢ₌₁^{m}∥fᵢ∥_{K}_{ᵢ}², as a loss, the minimax optimal recovery of (f₁^{†}, . . . , fₘ^{†}) is (f₁, . . . , fₘ) with

$${f}_{i} ( x ) = {K}_{i} ( x , X ) {K ( X , X )}^{- 1} Y , , \qquad ( 13 )$$

where K is the additive kernel

$$K = {\sum }_{i = 1}^{m} {K}_{i} .$$

The GP interpretation of this optimal recovery result is as follows. Let ξᵢ˜ [symbol] (0, Kᵢ) be m independent centered GPs with kernels Kᵢ. Write ξ for the additive GP ξ:=Σᵢ₌₁^{m}ξᵢ. (Eq. 13) can be recovered by replacing the modes fᵢ^{†} by independent centered GPS ξᵢ˜ [symbol] (0, Kᵢ) with kernels Kᵢ and approximating the mode i by conditioning ξᵢ on the available data ξ(X)=Y where ξ:=Σᵢ₌₁^{m} ξᵢ is the additive GP obtained by summing the independent GPS ξᵢ, i.e.,

$${f}_{i} ( x ) = 𝔼 [ {ξ}_{i} ( x ) \vert ξ ( X ) = Y ] .$$

Furthermore (f₁, . . . , fₘ) can also be identified as the minimizer of

$$\{ \begin{matrix}Minimize & {\sum }_{i = 1}^{m} {‖ {f}_{i} ‖}_{{K}_{i}}^{2} \\ over & ( {f}_{1} , … , {f}_{m} ) ∈ {ℋ}_{{K}_{1}} \times … \times {ℋ}_{{K}_{m}} \\ s . t . & ( {\sum }_{i = 1}^{m} {f}_{i} ) ( X ) = Y .\end{matrix} \qquad ( 14 )$$

The variational formulation (Eq. 14) can be interpreted as a generalization of Tikhonov regularization which can be recovered by selecting m=2, K₁ to be a smoothing kernel (such as a Matérn kernel) and K₂(x,y)=28 (x−y) to be a white noise kernel.

Now, this abstract KMD approach is associated with a quantification of how much each mode contributes to the overall data or how much each individual GP &i explains the data. More precisely, the activation of the mode i or GP ξᵢ can be quantified as

$$p ( i ) = \frac{{‖ {f}_{i} ‖}_{{K}_{i}}^{2}}{{‖ f ‖}_{K}^{2}} , \qquad ( 15 )$$

where f=Σᵢ₌₁^{m} fᵢ. These activations p(i) satisfy p(i)∈[0,1] and Σᵢ₌₁^{m} p(i)=1 they can be thought of as a generalization of Sobol sensitivity indices to the nonlinear setting in the sense that they are associated with the following variance representation/decomposition (writing [symbol] ·,· [symbol] _{K} for the RKHS inner product induced by K):

$$Var [ ξ , {f}_{K} ] = {‖ f ‖}_{K}^{2} = {\sum }_{i = 1}^{m} {‖ {f}_{i} ‖}_{{K}_{i}}^{2} = {\sum }_{i = 1}^{m} Var [ ξ , {f}_{K} ]$$

Now, looking back to the original manifold approximation problem 1 in the kernelized setting. Given the data X, we cannot regress an element f∈ [symbol] directly since the minimizer of ∥f∥_{K}²+γ−1∥f(X) [symbol] is the null function. To identify the functions ƒ∈ [symbol] , they need to be decomposed into modes that can be interpreted as a generalization of the notion of free and dependent variables. To describe this, assume that the kernel K can be decomposed as the additive kernel

$$K = {K}_{a} + {K}_{s} + {K}_{z} .$$

Then [symbol] _{K}= [symbol] _{K}_{ₐ}+ [symbol] _{K}_{ₛ}+ [symbol] _{K}_{_{z}} implies that for all function ƒ∈ [symbol] _{K}, f can be decomposed as f=fₐ+fₛ+f_{z} with (fₐ, fₛ, f_{z})∈ [symbol] ₐ× [symbol] ₛ× [symbol] _{z}.

Example 1 As a running example, take K to be the following additive kernel

$$K ( x , {x}^{′} ) = 1 + {β}_{1} {\sum }_{i} {x}_{i} {x}_{i}^{′} + {β}_{2} {\sum }_{i \leq j} {x}_{i} {x}_{j} {x}_{i}^{′} {x}_{j}^{′} + {β}_{3} {\prod }_{i} ( 1 + k ( {x}_{i} , {x}_{i}^{′} ) ) , \qquad ( 16 )$$

that is the sum of a linear kernel, a quadratic kernel and a fully nonlinear kernel. Take Kₐ to be the part of the linear kernel that depends only on x₁, i.e.,

$${K}_{a} ( x , {x}^{′} ) = {β}_{1} {x}_{1} {x}_{1}^{′} .$$

Take Kₛ to be the part of the kernel that does not depend on x₁, i.e.,

$${K}_{s} = 1 + {β}_{1} {\sum }_{i \neq 1} {x}_{i} {x}_{i}^{′} + {β}_{2} {\sum }_{i \leq j , i , j \neq 1} {x}_{i} {x}_{j} {x}_{i}^{′} {x}_{j}^{′} + {β}_{3} {\prod }_{i \neq 1} ( 1 + k ( {x}_{i} , {x}_{i}^{′} ) ) . \qquad ( 17 )$$

And take K_{z} to be the remaining portion,

$${K}_{z} = K - {K}_{a} - {K}_{s} .$$

Therefore the following questions are equivalent:
Given a function gₐ in the RKHS [symbol] _{K}_{ₐ} defined by the kernel Kₐ is there a function ƒₛ in the the RKHS [symbol] _{K}_{ₛ} defined by the kernel Kₛ such that gₐ(x)≈fₛ(x) for x∈ [symbol] ?
Given a function gₐ∈ [symbol] _{K}_{ₐ} is there a function ƒ in the RKHS [symbol] _{K} defined by the kernel K such that f(x)≈0 for x∈ [symbol] and such that its fₐ mode is −gₐ and its f_{z} mode is zero?

Then, the natural answer to these questions is to identify the modes of the constraint f=fₐ+fₛ+f_{z}∈ [symbol] (such that f(x)≈0 for x∈ [symbol] ) such that fₐ=−gₐ and f_{z}=0 by selecting fₛ to be the minimizer of the following variational problem

$${min}_{{f}_{s} ∈ {ℋ}_{s}} ‖ {f}_{s} ‖ {1}_{{K}_{s}}^{2} + \frac{1}{γ} {\vert ( - {g}_{a} + {f}_{s} ) ( ϕ ) \vert}^{2} \qquad ( 18 )$$

This is equivalent to introducing the additive GP ξ=ξₐ+ξₛ+ξ_{z}+ξₙ whose modes are the independent GPS ξₐ˜ [symbol] (0, Kₐ), ξₛ˜ [symbol] (0, Kₛ), ξ_{z}˜ [symbol] (0, K_{z}), ξₙ˜ [symbol] (0, γδ(x−y)) (use the label “n” in reference to “noise”), and then recovering fₛ as

$${f}_{s} = 𝔼 [ {ξ}_{s} \vert ξ ( X ) = 0 , {ξ}_{a} = - {g}_{a} , {ξ}_{z} = 0 ] .$$

Taking gₐ(x)=x₁ for running example 1, the questions are equivalent to asking whether there exists a function ƒₛ∈ [symbol] _{K}_{ₛ} that does not depend on x₁ (since Kₛ does not depend on x₁) such that

$${x}_{1} \approx {f}_{s} ( {x}_{2} , … , {x}_{d} ) for x ∈ ℳ .$$

Therefore, the mode fₐ can be thought of as a dependent mode (use the label “a” in reference to “ancestors”), the mode fₛ as a free mode (use the label “s” in reference to “signal”), the mode f₂ as a zero mode.

While the numerical illustrations have primarily focused on the scenario where gₐ takes the form of gₐ(x)=xᵢ, and the aim is to express xᵢ as a function of other variables, the generality of hypergraph discovery processes in accordance with a number of embodiments of the invention is motivated by their potential to recover implicit equations. For example, consider the implicit equation x₁²+x₂²=1, which can be retrieved by setting the mode of interest to be gₐ(x)=x₁² and allowing fₛ to depend only on the variable x₂.

Signal-to-noise ratio. Now, the following question: since the mode fₛ(the minimizer of (Eq. 18)) always exists and is always unique, how is it know that it leads to a valid constraint? To answer that question, compute the activation of the GPs used to regress the data. Write

$$V ( s ) := {‖ {f}_{S} ‖}_{{K}_{{s}^{′}}}^{2}$$

for the activation of the signal GP ξₛ and

$$V ( n ) := \frac{1}{γ} {\vert ( - {g}_{a} + {f}_{s} ) ( X ) \vert}^{2}$$

for the activation of the noise GP ξₙ, and then these allow a signal-to-noise ratio to be defined as

$$\frac{V ( s )}{V ( s ) + V ( n )} . \qquad ( 19 )$$

Note that this corresponds to activation ratio of the noise GP defined in (Eq. 15). This ratio can then be used to test the validity of the constraint in the sense that if V(s)/(V(s)+V(n))>τ (with τ=0.5 as a prototypical example), then the data is mostly explained by the signal GP and the constraint is valid. If V(s)/(V(s)+V (n))<τ, then the data is mostly explained by the noise GP and the constraint is not valid.

Iterating by removing the least active modes from the signal. If the constraint is valid, then the activation of the modes composing the signal can be computed. To describe this, assume that the kernel Kₛ can be decomposed as the additive kernel

$${K}_{s} = {K}_{s , 1} + … + {K}_{s , m} ,$$

which results in [symbol] _{K}_{ₛ}= [symbol] _{K}_{_{s,1}}+ . . . + [symbol] _{K}_{_{s,m}} which results in the fact that ∀fₛ∈ [symbol] ₛ, fₛ can be decomposed as

$${f}_{s} = {f}_{s , 1} + … + {f}_{s , m} ,$$

with f_{s,i}∈ [symbol] _{K}_{_{s,i}}. The activation of the mode i can then be quantified as p(i)=∥f_{s,i}∥_{K}_{_{s,i}}²/∥fₛ∥_{K}_{ₛ}², which combined with ∥fₛ∥_{K}_{ₛ}²=Σᵢ₌₁^{m}∥f_{s,i}∥K_{s,i}² leads to Σᵢ₌₁^{m} p(i)=1.

For running example 1, Kₛ=(Eq. 17) can be decomposed as the sum of an affine kernel, a quadratic kernel, and a fully nonlinear kernel, i.e., m=3, K_{s,1}=1+β₁ [symbol] xᵢxᵢ′, K_{s,2}=β₂ [symbol] xᵢxⱼxᵢ′xⱼ′ and K_{s,3}=β₃ Π_{i≠1} (1+k(xᵢ,xⱼ′)).

As another example for the running example, Kₛ can be taken to be the sum of the portion of the kernel that does not depend on x₁ and x₂ and the remaining portion, i.e., m=2, K_{s,1}=1+β₁ [symbol] xᵢxᵢ′+β₂ Σ_{i≤j,i,j≠1,2} xᵢxⱼxᵢ′xⱼ′+β₃ [symbol] (1+k(xᵢ,xᵢ′)) and K_{s,2}=Kₛ−K_{s,1}.

Then, these sub-modes can be ordered from most active to least active and create a new kernel Kₛ by removing the least active modes from the signal and adding them to the mode that is set to be zero. To describe this, let π(1), . . . , π(m) be an ordering of the modes by their activation, i.e., ∥f_{s,π(1)}∥_{K}_{_{s,π(1)}}²∥f_{s,π(2)}∥_{K}_{_{s,π(2)}}²≥ . . . .

Writing Kₜ=Σᵢ₌ᵣ₊₁^{m} K_{s,π(i)} for the additive kernel obtained from the least active modes (with r+1=m as the value used for our numerical implementations), update the kernels Kₛ and K₂ by assigning the least active modes from Kₛ to K_{z}, i.e., Kₛ−Kₜ→Kₛ and K_{z}+Kₜ→K_{z} (zero the least active modes).

Finally, the process in accordance with a variety of embodiments of the invention can be iterative. This iteration can be thought of as identifying the structure of the hypergraph by placing too many hyperedges and removing them according to the activation of the underlying GPs.

For the running example 1, in an attempt to identify the ancestors of the variable x₁, if the sub-mode associated with the variable x₂ is found to be least active, then try to remove x₂ from the list of ancestors and try to identify x₁ as a function of x₃ to x_{d}. This is equivalent to selecting Kₐ(x, x′)=γ₁x₁x₁′,

$${K}_{\frac{s}{t}} = 1 + {β}_{1} {\sum }_{i \neq 1 , 2} {x}_{i} {x}_{i}^{′} + {β}_{2} {\sum }_{i \leq j , i , j \neq 1 , 2} {x}_{i} {x}_{j} {x}_{i}^{′} {x}_{j}^{′} + {β}_{3} {\prod }_{i \neq 1 , 2} ( 1 + k ( {x}_{i} , {x}_{i}^{′} ) ) , \qquad ( 20 )$$

and K_{z∪t}=K−Kₐ−K_{s/t} to assess whether there exists a function ƒₛ∈ [symbol] _{K} that does not depend on x₁ and x₂ s.t. x₁≈fₛ(x₃, . . . , x_{d}) for x∈ [symbol] .

Alternative determination of the list of ancestors. Systems and methods in accordance with certain embodiments of the invention determine the list of ancestors of a given node using a fixed threshold (e.g., τ=0.5) to prune nodes. In some embodiments, an alternative approach that mimics the strategy employed in Principal Component Analysis (PCA) for deciding which modes should be kept and which ones should be removed is utilized. The PCA approach in accordance with several embodiments of the invention is to order the modes in decreasing order of eigenvalues/variance and (1) either keep the smallest number modes holding/explaining a given fraction (e.g., 90%) of the variance in the data, and/or (2) use an inflection point/sharp drop in the decay of the eigenvalues to select which modes should be kept. Hypergraph discovery processes in accordance with numerous embodiments of the invention employ an alternative determination of the least active mode by iteratively removing the mode that leads to the smallest increase in noise-to-signal ratio. In a variety of embodiments, the mode t is removed such that,

$$t = arg {min}_{t} \frac{V ( n )}{V ( s / t ) + V ( n )} .$$

For running example 1, in attempting to find the ancestors of the variable x₁, this is equivalent to removing the variables or node t whose removal leads to the smallest loss in signal-to-noise ratio (or increase in noise-to-signal ratio) by selecting

$${K}_{s / t} = 1 + {β}_{1} {\sum }_{i \neq 1 , t} {x}_{i} {x}_{i}^{′} + {β}_{2} {\sum }_{i \leq j , i , j \neq 1 , t} {x}_{i} {x}_{j} {x}_{i}^{′} {x}_{j}^{′} + {β}_{3} {\prod }_{i \neq 1 , t} ( 1 + k ( {x}_{i} , {x}_{i}^{′} ) ) .$$

Next, this process can be iterated, and (a) the noise-to-signal ratio, and (b) the increase in noise-to-signal ratio can be plotted as a function of the number of ancestors ordered according to this iteration. FIG. 10 illustrates this process and shows that the removal of an essential node leads to a sharp spike in increase in the noise-to-signal ratio (the noise-to-signal ratio jumps from approximately 50-60% to 99%). The identification of this inflection point can be used as a method for effectively and reliably pruning ancestors.

Hypergraph discovery in accordance with many embodiments of the invention may be described as follows: (1) For each variable of the hypergraph, try to approximate its values as a sum of noise and a function of the values of other variables in a given set of ancestors. (2) If the signal-to-ratio exceeds a given threshold, then iteratively remove variables that are least contributing to the signal until the signal-to-noise ratio drops a given threshold.

Hypergraph discovery methods in accordance with a number of embodiments of the invention receive data D (e.g., encoded into a matrix X) and a set of nodes V as an input and produces, for each node i∈V, its set of minimal ancestors Aᵢ and the simplest possible function ƒᵢ such that xᵢ≈fᵢ((xⱼ)_{j∈A}_{ᵢ}). It employs the default threshold (e.g., 0.5) on the signal-to-noise ratios for its operations. In several embodiments, processes normalize the data (e.g., via an affine transformation) so that the samples Xᵢ are of mean zero and variance 1. Given a node with index i=1 (for ease of presentation), processes in accordance with a variety of embodiments of the invention select a signal kernel of the form Kₛ=1+β₁ Σ_{i≠1} xᵢxᵢ′+β₂ [symbol] xᵢxⱼxᵢ′xⱼ′+β₃ [symbol] (1+k (xᵢ, xᵢ′)), (where k may be selected to be a vanilla RBF kernel such as Gaussian or Matérn), with 1≥β₁>0=β₂=β₃ for the linear kernel, 1≥β₁≥β₂>0=β₃ for the quadratic kernel and 1≥β₁≥β₂≥β₃>0 for the fully nonlinear (interpolative) kernel. In a variety of embodiments, processes compute the signal-to-noise ratio with gₐ(x)=x₁ and with the selected kernel. In many embodiments, the value of γ is selected automatically by maximizing the variance of the histogram of eigenvalues of D_{γ} (with the selected kernel and Y=gₐ(X) with gₐ(x)=x₁). In a number of embodiments, the value of γ is re-computed whenever a node is removed from the list of ancestors, and Kₛ is nonlinear. Processes in accordance with many embodiments of the invention iteratively identify the ancestor node t contributing the least to the signal and remove that node from the set of ancestors of the node if the removal of that node t does not send the signal-to-noise ratio below the default threshold (e.g., 0.5).

In several embodiments, rather than using a default static threshold (e.g., 0.5), processes compute the noise-to-signal ratio (NSR), represented as

$$\frac{V ( n )}{V ( s ) + V ( n )} ( q ) .$$

This ratio can be calculated as a function of the number q of ancestors, which may be ordered based on their decreasing contribution to the signal. Further descriptions of computing the NSR in accordance with a number of embodiments of the invention are described throughout this specification. In various embodiments, the final number q of ancestors can be determined by finding the value that maximizes the difference between successive noise-to-signal ratios,

$$\frac{V ( n )}{V ( s ) + V ( n )} ( q + 1 ) - \frac{V ( n )}{V ( s ) + V ( n )} ( q ) .$$

In various embodiments, the signal-to-noise ratio (SNR) depends on the prior on the level of noise. The signal-to-noise ratio (Eq. 19) depends on the value of γ, which is the variance prior on the level of noise. The goal of this subsection is to answer the following two questions: (1) How to select γ? (2) How to obtain a confidence level for the presence of a signal? Or equivalently for a hyperedge of the hypergraph? To answer these questions, the signal-to-noise ratio is analyzed in the following regression problem in which the unknown function ƒ^{†}: X→ [symbol] can be approximated based on noisy observations

$${f}^{†} ( X ) + σ Z = Y \qquad ( 21 )$$

of its values at collocation points Xᵢ (X,Y)∈ [symbol] ∈ [symbol] , Z∈ [symbol] , and the entries Zᵢ of Z are i.i.d [symbol] (0,1)). Assuming σ² to be unknown and writing γ for a candidate for its value, recall that the GP solution to this problem is approximate f^{†} by interpolating the data with the sum of two independent GPs, i.e.,

$$f ( x ) = 𝔼 [ ξ ( x ) \vert ξ ( X ) + \sqrt{γ} Z = Y ] , \qquad ( 22 )$$

where ξ˜ [symbol] (0, K) is the GP prior for the signal f^{†} and \sqrt{γZ}˜ [symbol] (0, γI_{N}) is the GP prior for the noise σZ in the measurements. f can also be identified as a minimizer of

$${minimize}_{{f}^{′}} {‖ {f}^{′} ‖}_{K}^{2} + \frac{1}{γ} {‖ {f}^{′} ( X ) - Y ‖}_{{ℝ}^{N}}^{2} , \qquad ( 23 )$$

the activation of the signal GP can be quantified as s=∥f∥_{K}², the activation of the noise GP can be quantified as

$$V ( n ) = \frac{1}{γ} {‖ f ( X ) - Y ‖}_{{ℝ}^{N}}^{2} .$$

Define the noise-to-signal ratio

$$\frac{V ( n )}{V ( s ) + V ( n )} ,$$

which admits the following representer formula,

$$\frac{V ( n )}{V ( s ) + V ( n )} = γ \frac{{{Y}^{T} ( K ( X , X ) + γ I )}^{- 2} Y}{{{Y}^{T} ( K ( X , X ) + γ I )}^{- 1} Y} . \qquad ( 24 )$$

Observe that when applied to the setting where mode fₛ always exists and is always unique, this signal-to-noise ratio is calculated with K=Kₛ and Y=gₐ(X).

The following proposition follows from (Eq. 24).

Proposition 8.1 It holds true that

$$\frac{v ( n )}{v ( s ) + v ( n )} ∈ [ 0 , 1 ] ,$$

and if K(X,X) has full rank,

$${lim}_{γ ↓ 0} \frac{v ( n )}{v ( s ) + v ( n )} = 0 and {lim}_{γ ↑ ∞} \frac{v ( n )}{v ( s ) + v ( n )} = 1. \qquad ( 25 )$$

Therefore, if the signal f^{†} and the level of noise σ² are both unknown, how should γ be selected to decide whether the data is mostly signal or noise?

In certain embodiments, selecting γ depends on whether the feature-map associated with the base kernel K is finite-dimensional or not. In a number of embodiments, if the feature-map associated with the base kernel K is finite-dimensional, then γ can be estimated from the data itself when the number of data-points is sufficiently large (at least larger than the dimension of the feature-space [symbol] ). A prototypical example (when trying to identify the ancestors of the variable x₁) is K=Kₛ=(Eq. 17) with β₃=0. In the general setting, assume that K(x, x′):=ψ(x)^{T}ψ(x′) where the range S of ψ is finite-dimensional. Assume that f^{†} belongs to the RKHS defined by ψ, i.e., assume that it is of the form f^{†}=v^{T}ψ for some v in the feature-space. Then (Eq. 21) reduces to

$${v}^{T} ψ ( X ) + σ Z = Y , \qquad ( 26 )$$

and, in the large data regime, σ² can be estimated by

$${\overline{σ}}^{2} := \frac{1}{N} {inf}_{w ∈ 𝒮} {‖ {w}^{T} ψ ( X ) - Y ‖}_{{ℝ}^{N}}^{2} . \qquad ( 27 )$$

When the feature map is finite-dimensional, select

$$γ = N {\overline{σ}}^{2} = {inf}_{w ∈ 𝒮} {‖ {w}^{T} ψ ( X ) - Y ‖}_{{ℝ}^{N}}^{2} . \qquad ( 28 )$$

In certain embodiments, if the feature-map associated with the base kernel K is infinite-dimensional (or has more dimensions than data points) then it can interpolate the data exactly and the previous strategy cannot be employed since the minimum of (Eq. 27) is zero. A prototypical example (when trying to identify the ancestors of the variable x₁) is K=Kₛ=(Eq. 17) with β₃>0. In this situation, the level of noise σ may not be estimated, but a prior γ may be selected such that the resulting noise-to-signal ratio can effectively differentiate noise from signal. To describe this, observe that the noise-to-signal ratio (Eq. 24) admits the representer formula

$$\frac{v ( n )}{v ( s ) + v ( n )} = \frac{{Y}^{T} {D}_{γ}^{2} Y}{{Y}^{T} {D}_{γ} Y} , \qquad ( 29 )$$

involving the N×N matrix

$${D}_{γ} := γ {( K ( X , X ) + γ I )}^{- 1} . \qquad ( 30 )$$

Observe that 0≤D_{γ}≤I, and

$${lim}_{γ ↓ 0} {D}_{γ} = 0 and {lim}_{γ ↑ ∞} {D}_{γ} = I . \qquad ( 31 )$$

Write (λᵢ, eᵢ) for the eigenpairs of K(X,X)(K(X,X)eᵢ=λᵢeᵢ) where the λᵢ are ordered in decreasing order. Then the eigenpairs of D_{γ} are (ωᵢ, eᵢ) where

$${ω}_{i} := \frac{γ}{γ + {λ}_{i}} . \qquad ( 32 )$$

Note that the ωᵢ are contained in [0,1] and also ordered in decreasing order.

Writing Y̅ᵢ for the orthogonal projection of Y onto eᵢ,

$$\frac{v ( n )}{v ( s ) + v ( n )} = \frac{{\sum }_{i = 1}^{n} {ω}_{i}^{2} {\overline{Y}}_{i}^{2}}{{\sum }_{i = 1}^{n} {ω}_{i} {\overline{Y}}_{i}^{2}} , \qquad ( 33 )$$

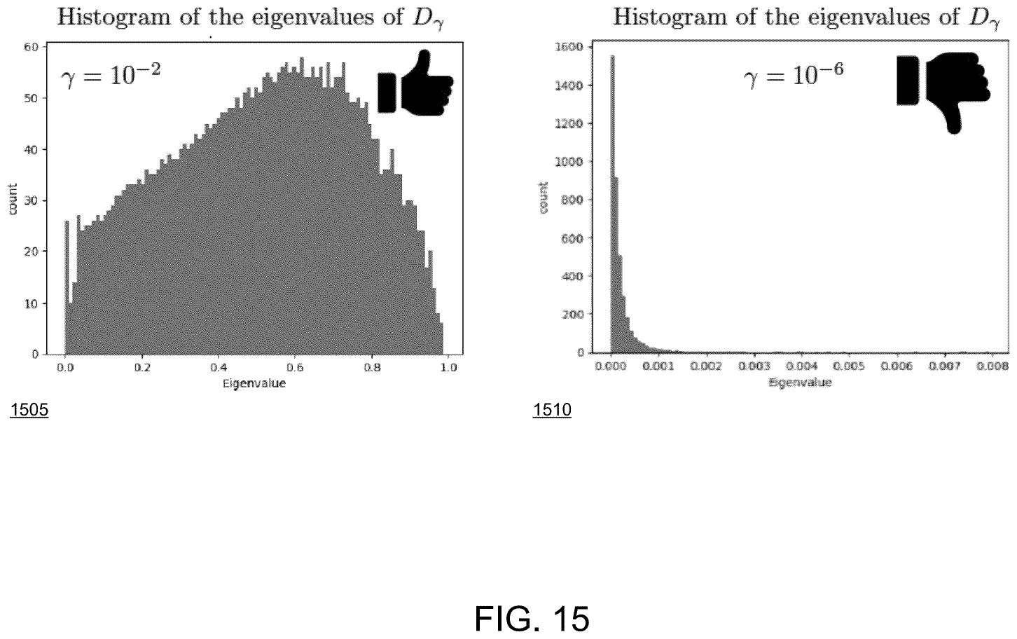

It follows that if the histogram of the eigenvalues of D_{γ} is concentrated near 0 or near 1, then the noise-to-signal ratio is non-informative since the prior γ dominates it. To avoid this phenomenon, processes in accordance with certain embodiments of the invention select γ so that the eigenvalues of D_{γ} are well spread out in the sense that the histogram of its eigenvalues has maximum or near-maximum variance. An example of histograms of eigenvalues of D_{γ} are illustrated in FIG. 15. In this example, histogram 1505 is more spread out and is a good choice for γ, while histogram 1510 is not spread out and a poor choice for γ. If the eigenvalues have an algebraic decay, then this is equivalent to taking γ to be the geometric mean of those eigenvalues.

In various embodiments, an optimizer can be used to obtain γ by maximizing the sample variance of (ωᵢ)ᵢ₌₁ⁿ. If this optimization fails, processes in accordance with some embodiments of the invention can default to the median of the eigenvalues. This can ensure a balanced, well-spread spectrum for D_{γ}, with half of the eigenvalues λᵢ being lower and half being higher than the median.

The purpose of this section is to present a rationale for the choices for γ in accordance with many embodiments of the invention. We present an asymptotic analysis of the signal-to-noise ratio in the setting of a simple linear regression problem. According to (Eq. 28), γ must scale linearly in N; this scaling is necessary to achieve a ratio that represents the signal-to-noise per sample. Without it (if γ remains bounded as a function of N), this scaling of the signal-to-noise would converge towards 0 as N→∞. To see how, consider a simple example in which we seek to linearly regress the variable y as a function of the variable x, both taken to be scalar (in which case ψ(x)=x). Assume that the samples are of the form Yᵢ=aXᵢ+σZᵢ for i=1, . . . , N, where a, σ [symbol] 0, the Zᵢ are i.i.d. [symbol] (0,1) random variables, and the Xᵢ satisfy

$$\frac{1}{N} {\sum }_{i = 1}^{N} {X}_{i} = 0 and \frac{1}{N} {\sum }_{i = 1}^{N} {X}_{i}^{2} = 1 .$$

Then, the signal-to-noise ratio is

$$\frac{𝒱 ( s )}{𝒱 ( s ) + 𝒱 ( n )}$$

with V(s)=|v|² and

$$𝒱 ( n ) = \frac{1}{γ} {\sum }_{i = 1}^{N} {\vert {vX}_{i} - {Y}_{i} \vert}^{2}$$

and v is a minimizer of

$${min}_{v ∈ ℝ} {\vert v \vert}^{2} + \frac{1}{γ} {\sum }_{i = 1}^{N} {\vert {vX}_{i} - {Y}_{i} \vert}^{2} . \qquad ( 34 )$$

In asymptotic N→∞ regime,

$$v \approx \frac{aN}{γ + N}$$

and

$$\frac{v ( s )}{v ( s ) + v ( n )} \approx \frac{\frac{γ}{N} {a}^{2}}{- {a}^{2} ( γ / N + 1 ) + ( {a}^{2} + {σ}^{2} ) {( γ / N + 1 )}^{2}} . \qquad ( 35 )$$

If γ is bounded independently from N, then

$$\frac{v ( s )}{v ( s ) + v ( n )}$$

converges towards zero as N→∞, which is undesirable as it does not represent a signal-to-noise ratio per sample. If γ=N, then

$$\frac{𝒱 ( s )}{𝒱 ( s ) + 𝒱 ( n )} \approx \frac{{a}^{2}}{4 {σ}^{2} + 2 {a}^{2}} ,$$

which does not converge to 1 as a→¢ and σ→0, which is also undesirable. If γ is taken as in (Eq. 28), then γ≈Nσ² and

$$\frac{𝒱 ( s )}{𝒱 ( s ) + 𝒱 ( n )} \approx \frac{{a}^{2}}{( {σ}^{2} + 1 ) ( {a}^{2} + {σ}^{2} + 1 )} , \qquad ( 36 )$$

which converges towards 0 as σ→∞ and towards 1/(1+σ²) as a→∞, which has, therefore, the desired properties.

When the kernel can interpolate the data exactly, (Eq. 27) should not be used to estimate the level of noise σ. For a finite-dimensional feature map ψ, with data (X,Y), Y=v^{T}ψ(X)+σZ can be decomposed into a signal part Yₛ and noise part Yₛ, s.t. Y=Yₛ+Yₙ. While Yₛ belongs to the linear span of eigenvectors of K(X,X) associated with non-zero eigenvalues, Yₙ also activates the eigenvectors associated with with the null space of K(X,X) and the projection of Y onto that null-space is what allows γ to be derived. Since in the interpolatory case, all eigenvalues are strictly positive, we need to choose which eigenvalues are associated with noise differently, as is described in the previous section. With a fixed γ, if λᵢ>>γ, then ωᵢ≈0, which contributes in (Eq. 33) to yield a low noise-to-signal ratio. Similarly, if λᵢ<<γ, this eigenvalue yields a high noise-to-signal ratio. Thus, the choice of γ assigns a noise level to each eigenvalue. While in the finite-dimensional feature map setting, this assignment is binary, here soft thresholding can be performed using λ [symbol] γ/(γ+λ) to indicate the level of noise of each eigenvalue. This interpretation sheds light on the selection of γ in equation (Eq. 28). Let ψ represent the feature map associated with K. Assuming the empirical mean of ψ(Xᵢ) is zero, the matrix K(X,X) corresponds to an unnormalized kernel covariance matrix ψ^{T}(X)ψ(X). Consequently, its eigenvalues correspond to N times the variances of the ψ(Xᵢ) across various eigenspaces. After conducting Ordinary Least Squares regression in the feature space, if the noise variance is estimated as σ̅², then any eigenspace of the normalized covariance matrix whose eigenvalue is lower than σ̅² cannot be recovered due to the noise. Given this, the soft thresholding cutoff can be set to be γ=Nσ̅² for the unnormalized covariance matrix K(X,X).

If the noise is only comprised of noise, then an interval of confidence can be obtained on the noise-to-signal ratio. To describe this consider the problem of testing the null hypothesis H₀: f^{†}=0 (there is no signal) against the alternative hypothesis H₁: f^{†} [symbol] 0 (there is a signal). Under the null hypothesis H₀, the distribution of the noise-to-signal ratio (Eq. 29) is known and it follows that of the random variable

$$B := \frac{{Z}^{T} {D}_{γ}^{2} Z}{{Z}^{T} {D}_{γ} Z} . \qquad ( 37 )$$

Therefore, the quantiles of B can be used as an interval of confidence on the noise-to-signal ratio if H₀ is true. More precisely, selecting β such that [symbol] [B≤β_{α}]≈α with α=0.05 as a prototypical example, the noise-to-signal ratio (Eq. 29) would be expected, under H₀, to be larger than β_{α} with probability≈1−α. The estimation of β requires Monte-Carlo sampling.

In some embodiments, an alternative approach (in the large data regime) to using the quantile β_{α} is to use the Z-score

$$𝒵 := \frac{\frac{{Y}^{T} {D}_{γ}^{2} Y}{{Y}^{T} {D}_{γ} Y} - 𝔼 [ B ]}{\sqrt{Var [ B ]}} , \qquad ( 38 )$$

after estimating [symbol] [B] and Var[B] via Monte-Carlo sampling. In particular, if H₀ is true then |Z|≥z_{α} should occur with probability≈α with z_{0.1}=1.65, z_{0.05}=1.96 and z_{0.01}=2.58.

Remark 8.2 Although the quantile β_{α} or the Z-score Z can be employed to produce an interval of confidence on the noise-to-signal ratio under H₀, they should not be used as thresholds for removing nodes from the list of ancestors. Indeed, observing a noise-to-signal ratio (Eq. 29) below the threshold β_{α} does not imply that all the signal has been captured by the kernel; it only implies that some signal has been captured by the kernel K. To illustrate this point, consider the setting where one tries to approximate the variable x₁ as a function of the variable x₂. If x₁ is not a function of x₂, but of x₂ and x₃, as in x₁=cos(x₂)+sin(x₃), then applying the proposed approach with Y encoding the values of x₁, X encoding the values of x₂, and the kernel K depending on x₂ could lead to a noise-to-signal ratio below Ba due to the presence of a signal in x₂. Therefore, although the variable x₃ is missing in the kernel K, a possibly low noise-to-signal ratio may still be observed due to the presence of some signal in the data. Summarizing, if the data only contains noise then

$$\frac{𝒱 ( n )}{𝒱 ( s ) + 𝒱 ( n )} \geq {β}_{α}$$

should occur with probability 1−α. If the event

$$\frac{𝒱 ( n )}{𝒱 ( s ) + 𝒱 ( n )} < {β}_{α}$$

is observed in the setting of K=K_{s/t}=(Eq. 20) where the ancestors of x₁ are identified, then it can only be deduced that x₃, . . . , x_{d} contain some signal but perhaps not all of it (processes in accordance with many embodiments of the invention may use this a criterion for pruning x₂).

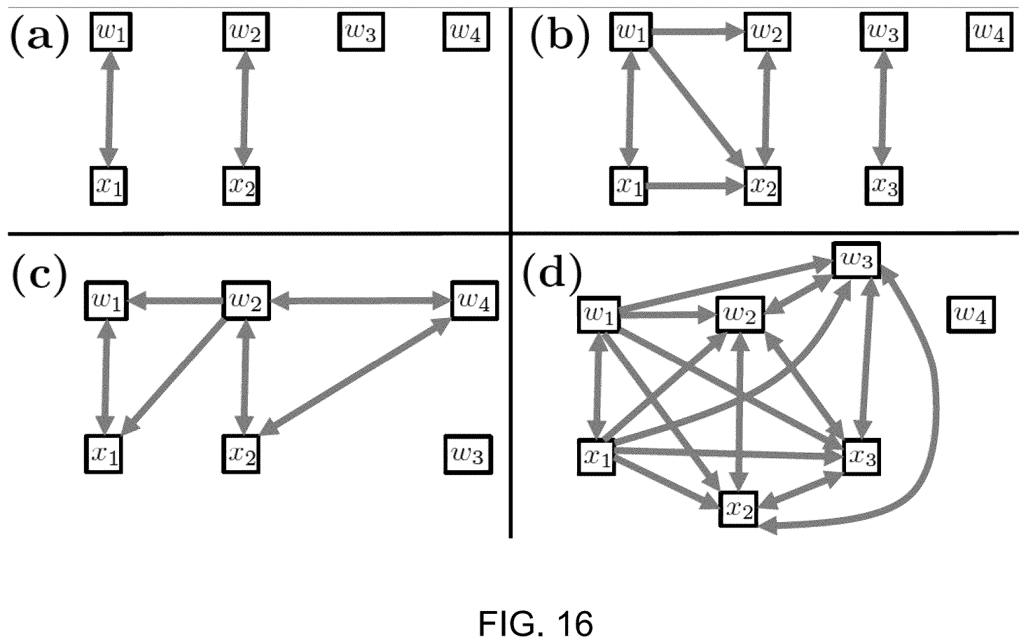

Examples of the recovery of functional dependencies from data are illustrated in FIG. 16. These examples illustrate the application of the proposed approach to the recovery of functional dependencies from data satisfying hidden algebraic equations. In all these examples, there are d=6 or d=7 variables and N=1000 samples from those variables. For d=6, the variables are w₁, w₂, w₃, w₄, x₁, x₂. For d=7, the variables are w₁, w₂, w₃, w₄, x₁, x₂, x₃. The samples from the variables w₁ to w₄ are i.i.d. [symbol] (0,1) random variables, and the samples from x₁, x₂ (and x₃ for d=7) are functionally dependent on the other variables.

In the example of FIG. 16(a), d=6 and the samples from x₁ and x₂ satisfy the equations

$${x}_{1} = {w}_{1} and {x}_{2} = {w}_{2} .$$

FIG. 16(a) shows the hypergraph recovered by selecting a kernel and pruning based on a difference between successive noise-to-signal ratios. The recovery is accurate and illustrates the one-to-one mappings between x₁ and w₁, as well as between x₂ and w₂.

In FIG. 16(b), d=7 and the samples from x₁, x₂ and x₃ satisfy the equations

$${x}_{1} = {w}_{1} , {x}_{2} = {x}_{1}^{2} + 1 + 0.1 {w}_{2} , and {x}_{3} = {w}_{3} .$$

FIG. 16(b) shows the hypergraph recovered by hypergraph discovery processes as described in this description. Hypergraph discovery processes in accordance with a variety of embodiments of the invention select the quadratic kernel and FIG. 16(b) shows the recovered graph (which is exact). The direct correspondence between x₁ and w₁ is correctly identified, as well as between x₃ and w₃. Yet, the efficiency of hypergraph discovery processes may be compromised when duplicate variables are present. For instance, given the quadratic kernel, even though x₂ can trace back its origin to either x₁ and w₂ or w₁ and w₂, the hypergraph discovery process recognizes x₁, w₁, and w₂ as its ancestors. This underscores the significance of eliminating redundant variables in accordance with a variety of embodiments of the invention when aiming to derive the sparsest and the most understandable graph.

In the example of FIG. 16(c), d=6 and the samples from x₁ and x₂ satisfy the equations

$${x}_{1} = {w}_{1} {w}_{2} and {x}_{2} = {w}_{2} sin ( {w}_{4} ) .$$

FIG. 16(c) shows the hypergraph recovered by the proposed approach using hypergraph discovery processes as described in this description. The process selects the nonlinear kernel and FIG. 16(c) shows the recovered graph (which is exact). The underlying functional dependencies are inherently nonlinear and were not explicitly represented in our feature maps. By utilizing the fully nonlinear kernel (Eq. 16), the hypergraph discovery process identified the correct functional dependencies.

In the example of FIG. 16(d), d=7 and the samples from x₁, x₂ and x₃ satisfy the equations

$${x}_{1} = {w}_{1} , {x}_{2} = {x}_{1}^{3} + 1 + 0.1 {w}_{2} and {x}_{3} = {( {x}_{1} + 2 )}^{3} + 0.1 {w}_{3} . \qquad ( 39 )$$

FIG. 16(d) shows the hypergraph recovered with a hypergraph discovery process in accordance with several embodiments of the invention. Given the kernel selections (linear, quadratic, and fully nonlinear), one might anticipate an approximate recovery of the equations via the fully nonlinear kernel, especially as the equation appears to be cubic. However, the hypergraph discovery process astutely identifies an alternative combination, revealing hidden quadratic dependencies between variables and permitting an exact recovery with the quadratic kernel. Notably, upon expanding (x₁+2)³, it becomes evident that the cubic terms can be portrayed using linear and quadratic combinations of other nodes. Such an automatic simplification in equations is undeniably profound. Such automatic discovery of simplifying equations is very powerful. Yet, it is worth mentioning that to achieve this exact quadratic recovery; more ancestors must be considered than originally denoted in (Eq. 39). This emphasizes the notion that functional dependencies are profoundly influenced by the chosen function form, and hypergraph discovery processes in accordance with a variety of embodiments of the invention discern one of the potential dependencies.

Referring back to the example of recovery of chemical reaction networks, the proposed mechanism for the hydrogenation of ethylene (C₂H₄) to ethane (C₂H₆), is (writing [H] for the concentration of H) modeled by the following system of differential equations

$$\begin{matrix}\frac{d [ {H}_{2} ]}{dt} & = - {k}_{1} [ {H}_{2} ] + {{k}_{- 1} [ H ]}^{2} \\ \frac{d [ H ]}{dt} & = 2 {k}_{1} [ {H}_{2} ] - 2 {{k}_{- 1} [ H ]}^{2} - {k}_{2} [ {C}_{2} {H}_{4} ] [ H ] - {k}_{3} [ {C}_{2} {H}_{5} ] [ H ] \\ \frac{d [ {C}_{2} {H}_{4} ]}{dt} & = - {k}_{2} [ {C}_{2} {H}_{4} ] [ H ] \\ \frac{d [ {C}_{2} {H}_{5} ]}{dt} & = {k}_{2} [ {C}_{2} {H}_{4} ] [ H ] - {k}_{3} [ {C}_{2} {H}_{5} ] [ H ]\end{matrix} \qquad ( 40 )$$

The primary variables are the concentrations [H₂], [H], [C₂H₄] and [C₂H₅] and their time derivatives

$$\frac{d [ {H}_{2} ]}{dt} , \frac{d [ H ]}{dt} , \frac{d [ {C}_{2} {H}_{4} ]}{dt} and \frac{d [ {C}_{2} {H}_{5} ]}{dt} .$$

The computational hypergraph encodes the functional dependencies (Eq. 40) associated with the chemical reactions. The hyperedges of the hypergraph are assumed to be unknown and the primary variables are assumed to be known. Given N samples from the graph of the form

$${( [ {H}_{2} ] ( {t}_{i} ) , [ H ] ( {t}_{i} ) , [ {C}_{2} {H}_{4} ] ( {t}_{i} ) , [ {C}_{2} {H}_{5} ] ( {t}_{i} ) )}_{i = 1 , … , N} \qquad ( 41 )$$

the objective is to recover the structure of the hypergraph given by (Eq. 40), representing the functions by hyperedges. A dataset of the form (Eq. 41) was created by integrating 50 trajectories of (Eq. 40) for different initial conditions, and each equispaced 50 times from t=0 to t=5. It is imposed that the information that the derivative variables are functions of the non-derivative variables to avoid ambiguity in the recovery, as (Eq. 40) is not the unique representation of the functional relation between nodes in the graph. In this example, processes in accordance with many embodiments of the invention were performed with weights β=[0.1, 0.01, 0.001] for linear, quadratic, and nonlinear, respectively. The proposed approach leads to a perfect recovery of the computation graph illustrated in FIG. 7. The approach obtains a perfect recovery of the computational graph and a correct identification of the relations being quadratic.

Hypergraph discovery in accordance with a number of embodiments of the invention was applied as a statistical analysis tool to scrutinize COVID-19 open data. In this example, categorical data are treated as scalar values, with all variables scaled to achieve a mean of 0 and a variance of 1. Three distinct kernel types were implemented: linear, quadratic, and Gaussian, with a length scale of 1 for the latter. A weight ratio of 1/10 is assigned between kernels, signifying that the quadratic kernel is weighted ten times less than the linear kernel. Lastly, the noise parameter, γ, is determined using processes as described throughout this description.

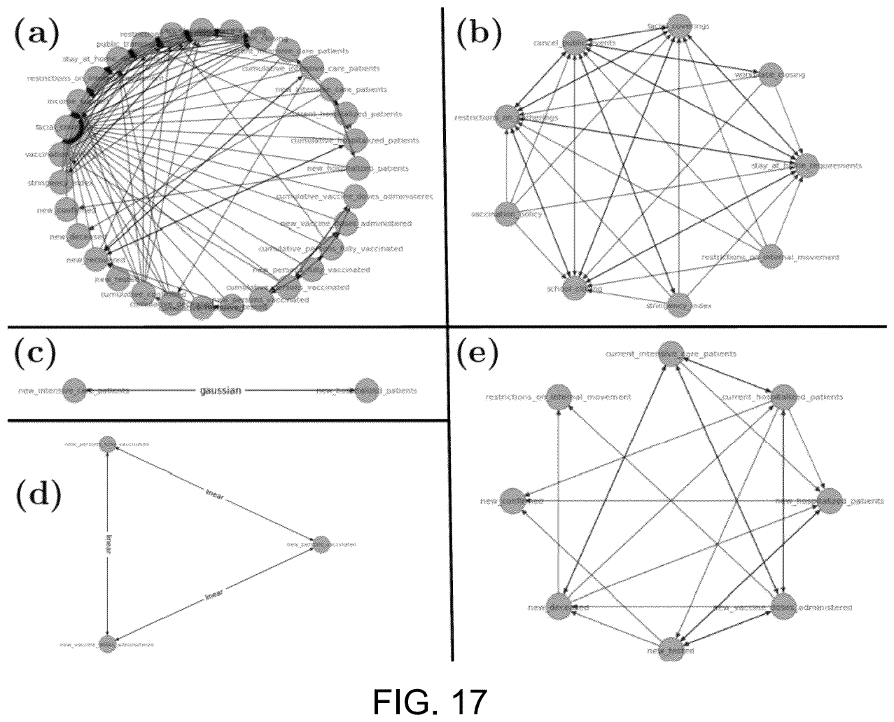

An example of hypergraph discovery with COVID-19 data in accordance with an embodiment of the invention is illustrated in FIG. 17. Initially, a complete graph is constructed using all variables. An example of a complete, full recovered graph in accordance with an embodiment of the invention is illustrated in FIG. 17(a). The construction in this example was done using only linear and quadratic kernels. Processes in accordance with a variety of embodiments of the invention can use only linear and quadratic kernels to regularise the problem by choosing a feature map whose dimension is not too high.

A notably clustered section within the graph of FIG. 17(a) is observed upon examination. FIG. 17(b) offers an in-depth view of this cluster, revealing its representation of the government's pandemic response. Specifically, FIG. 17(b) shows the node 1705 corresponding to the variable “schools closing” revealing that the government either implemented multiple restrictive measures simultaneously or lifted them in unison. A few representative nodes (e.g., “schools closing”) for the cluster are selected, ones with few ancestors and serving as an ancestor to numerous nodes. In this example, although mask mandates also has few ancestors and serves as an ancestor to numerous nodes, the SNR level for the relationship is low and was on the verge of being identified as noise). Representative nodes in accordance with numerous embodiments of the invention are selected based on various factors, such as (but not limited to) a number of ancestors for a given node, a number of nodes to which a given node is an ancestor, a SNR level for a kernel to a given node, etc. The vaccination policy and stay-at-home requirements are deemed an apt choice in this context, especially given their impact on the population.

In some embodiments, hypergraph discovery processes may identify redundant information by identifying loops in the hypergraph. Identifying redundant information in accordance with numerous embodiments of the invention may be performed as part of the pruning process (e.g., prior to pruning for a given node, after all nodes have been pruned, etc.). Examples of loops (or clusters) in the example of FIG. 17 are illustrated in FIGS. 17(c-d). New vaccinations form a cluster (FIG. 17(d)), displaying a linear relationship between nodes, signaling redundant information. The hospitalization cluster (FIG. 17(c)) reveals a nonlinear relationship between nodes. When nodes are related in this way, processes in accordance with a number of embodiments of the invention can eliminate (or consolidate) the redundant nodes. In numerous embodiments, eliminating redundant nodes can be performed prior to or as a part of ancestor pruning. Eliminating redundant nodes is vital for two reasons: firstly, it improves the graph's readability, especially with 31 variables; secondly, it avoids hindering graph discovery. Eliminating redundant nodes leads to the sparse graph shown in FIG. 17(e), which is interpretable and amenable to (both quantitative and qualitative) analysis. In an extreme case, treating two identical variables as distinct would result in one variable's ancestor simply being its duplicate, yielding an uninformative graph.

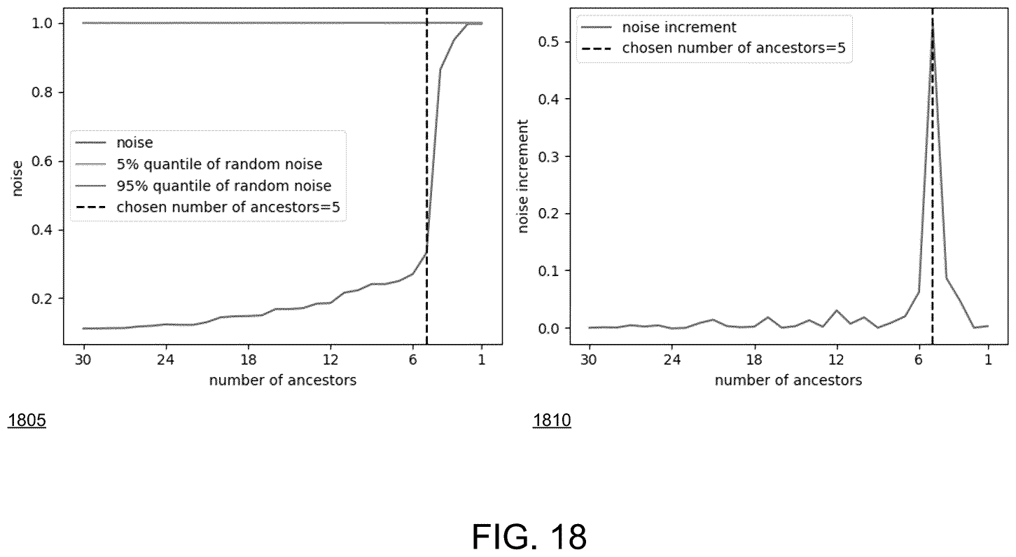

An example of the evolution of the observed signal-to-noise ratio when pruning ancestors in accordance with an embodiment of the invention is illustrated in FIG. 18. In this case, it is very clear where to stop pruning, as the jumping noise ratio is significant. Chart 1805 shows the noise-to-signal ratio (and chart 1810 its increments) as a function of the number of ancestors of the “cumulative number of hospitalized patients” variable. Even for this real dataset, the proposed approach gives a clear signal for stopping the pruning process.

Subsequently, the hypergraph discovery process is rerun, with reduced variables due to eliminating redundancy, ushering us into a predominantly noisy regime. With fewer variables available, the Gaussian kernel may also be used. Two indicators are employed to navigate our discovery process: the signal-to-noise ratio and the Z-test. The former quantifies the degree to which the regression is influenced by noise, while the latter signals the existence of any signal. Results of in the graph presented in FIG. 17(e). Here, some ancestor relationships are logical when interpreting using our experience of the COVID-19 pandemic. For instance, the number of new hospitalized and new deceased appear closely linked. Indeed, most recorded deaths are from people in a hospital. Additionally, it is observed that many ancestors are needed to explain the number of people tested. This number depends not only on the state of the epidemic but also on the government's and the population's reaction. Furthermore, many tests are conducted during holidays such as Christmas, regardless of the current pandemic status. This widespread testing complicates the ability to predict testing based solely on present variables. However, it is vital to acknowledge that not all relationships in the graph necessarily suggest causal connections. Our method determines graph edges based on functional relationships, not causal ones. Ultimately, this graph demonstrates sparsity, facilitating a superior understanding of the data's underlying structure. Furthermore, the method allows us to identify and eliminate redundant information, enhancing clarity regarding the most pivotal trends observed.

Lastly, hypergraph discovery in accordance with various embodiments of the invention was applied to discover a hierarchy of functional dependencies in biological cellular signaling networks. In this experiment, single-cell data was used, consisting of the d=11 phosphoproteins and phospholipids levels in the human immune system T-cells that were measured using flow cytometry. This dataset was studied from a probabilistic modeling perspective in previous works. Existing methods have been used to learn a directed acyclic graph to encode causal dependencies or to learn an undirected graph of conditional independencies between the d molecule levels by assuming the underlying data follows a multivariate Gaussian distribution. The latter analysis encodes acyclic dependencies but does not identify directions. In some embodiments, hypergraph discovery identifies functional dependencies without imposing strong distributional assumptions on the data.

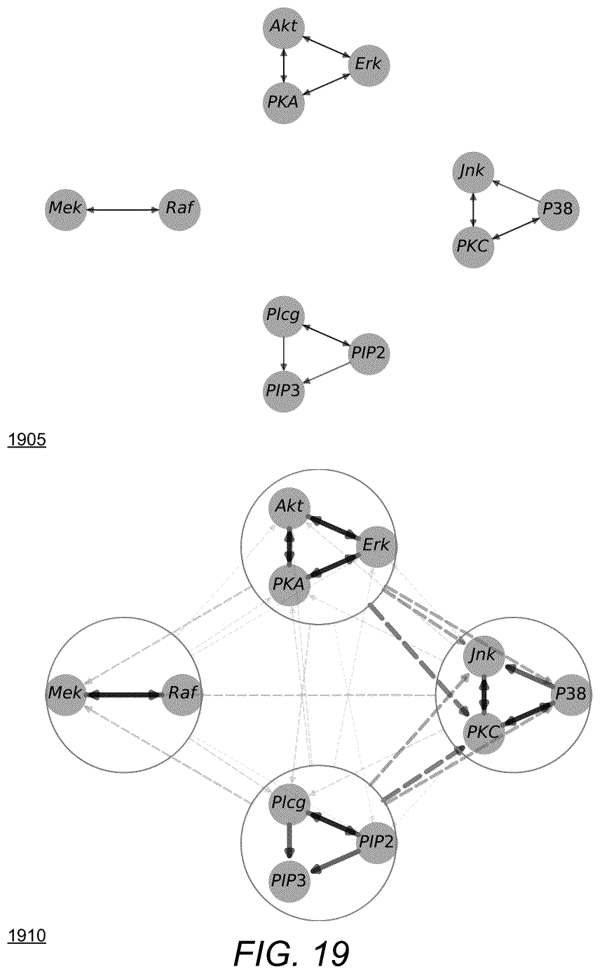

To identify the ancestors of each node, processes in accordance with certain embodiments of the invention can learn the dependencies using only linear and quadratic kernels. An example of hypergraph discovery in biological cellular signaling networks in accordance with an embodiment of the invention is illustrated in FIG. 19. The first graph 1905 of FIG. 19 identifies the resulting graph learned given a subset of N=2,000 samples chosen uniformly at random from the dataset consisting of 11 proteins and 7446 samples of their expressions. The graph identified by a hypergraph process consists of four disconnected clusters where the molecule levels in each cluster are closely related by linear or quadratic dependencies (all connections are linear except for the connection between Akt and PKA, which is quadratic). These edges match a subset of the edges found in the gold standard model. With perfect dependencies that have no noise, one can define constraints that reduce the total number of variables in the system. For this noisy dataset, these dependencies can be treated as forming groups of similar variables and introduce a hierarchical approach to learn the connections between groups.

Hypergraph discovery processes in accordance with several embodiments of the invention can identify relationships (or connections) between nodes and/or clusters at multiple levels. In the second graph 1910 of FIG. 19, solid arrows indicate strong intra-cluster connections identified in the first level, and dashed lines indicate weaker connections between nodes and clusters identified in the second level. The width and grayscale intensities of each edge correspond to its signal-to-noise ratio.

In a variety of embodiments, processes run a hypergraph discovery process after grouping the molecules into clusters to learn the connections between groups of variables within each cluster with nonlinear kernels and obtain the graph 1910 in FIG. 19. For each node in the graph, the ancestors of each node were identified by constraining the dependence to be a subset of the clusters. In other words, when identifying the ancestors of a given node i in cluster C, hypergraph discovery processes in accordance with several embodiments of the invention are only permitted to (1) use ancestors that do not belong to cluster C, and (2) include all or none of the variables in each cluster (j in cluster D [symbol] C is listed as an ancestor if and only if all other nodes j′ in cluster D are also listed as ancestors). In this example, the ancestors were identified using a Gaussian (fully nonlinear) kernel and the number of by ancestors were selected manually based on the inflection point in the noise-to-signal ratio.

In graph 1910, each edge is weighted based on its signal-to-noise ratio. There is a stronger dependence of the Jnk, PKC, and P38 cluster on the PIP3, Plcg, and PIP2 cluster, which closely matches the gold standard model. As compared to approaches based on acylic DAGs, however, graph 1910 also contains feedback loops between the various molecule levels.

While the Bayesian network analysis rely on the control of the sampling of the underlying variables (the simultaneous measurement of multiple phosphorylated protein and phospholipid components in thousands of individual primary human immune system cells, and perturbing these cells with molecular interventions), the reconstruction obtained by hypergraph discovery did not use this information and recovered functional dependencies rather than causal dependencies. Interestingly, the information recovered appears to complement and enhance other findings (e.g., the linear and noiseless dependencies between variables in the JNK cluster is not something that could easily be inferred from the graph produced in other processes).

In numerical experiments, hypergraph discovery in accordance with a number of embodiments of the invention maintains robustness with respect to the selection of the signal kernel, i.e., the Bi in the kernel (Eq. 1). Furthermore, the noise prior variance γ identified by hypergraph discovery is very close to the regularization term that minimizes cross-validation mean square loss. More precisely, the identification of functional dependencies between variables relies on regressing input-output data (X,Y) for the signal function ƒ with a kernel K and a nugget term γ (f(·)=K (·, X) (K(X,X)+γI)⁻¹Y). Writing (X^{c}, Y^{c}) for a subset of the input-output data, f^{c}(·)=K(·, X^{c}) (K(X^{c}, X^{c})+γI)⁻¹Y^{c} for the corresponding kernel ridge regressor, and γ_{c} for the minimizer of L² error ∥Y−f^{c}(X)∥, the value of γ selected by our algorithm is very close to γ_{c}. This suggests that one could also use cross-validation (applied to recover the signal function between a given node and a group of nodes in computing a noise-to-signal ratio) to select γ in accordance with several embodiments of the invention.

In several embodiments, forming clusters from highly interdependent variables helps to obtain a sparser graph. Additionally, the precision of the pruning process can be enhanced in accordance with various embodiments of the invention by avoiding the division of node activation within the cluster among its separate constituents. From the algebraic equation recovery examples above, we can only hope to recover equivalent equations, and the type of equations recovered depends on the kernel employed for the signal.

Systems and methods in accordance with several embodiments of the invention provide a comprehensive Gaussian Process framework for solving Type 3 (hypergraph discovery) problems, which is interpretable and amenable to analysis. The breadth and complexity of Type 3 problems significantly surpass those encountered in Type 2 (hypergraph completion), and the initial numerical examples presented serve as a motivation for the scope of Type 3 problems and the broader applications made possible by this approach. Hypergraph discovery in accordance with certain embodiments of the invention is designed to be fully autonomous, yet it offers the flexibility for manual adjustments to refine the graph's structure recovery. It aims to incorporate a distinct kind of information into the graph's structure, namely, the functional dependencies among variables rather than their causal relationships.

Additionally, hypergraph discovery in accordance with certain embodiments of the invention eliminates the need for a predetermined ordering of variables, a common requirement in acyclic probabilistic models where determining an optimal order is an NP-hard problem usually tackled using heuristic approaches. Furthermore, processes in accordance with certain embodiments of the invention can actually be utilized to generate such an ordering by quantifying the strength of the connections it recovers. In various embodiments, the Uncertainty Quantification properties of the underlying Gaussian Processes can be employed to quantify uncertainties in the structure of the recovered graph. While the uncertainty quantification (UQ) properties of Gaussian Processes (GPS) lack a direct equivalent in Deep Learning, hypergraph discovery in accordance with some embodiments of the invention encompasses richly hyperparametrized kernels to facilitate its extension to Deep Learning type connections between variables. This can be achievable by interpreting neural networks as hyperparameterized feature maps.

### A. Systems for Hypergraph Discovery

### 5. Hypergraph Discovery System

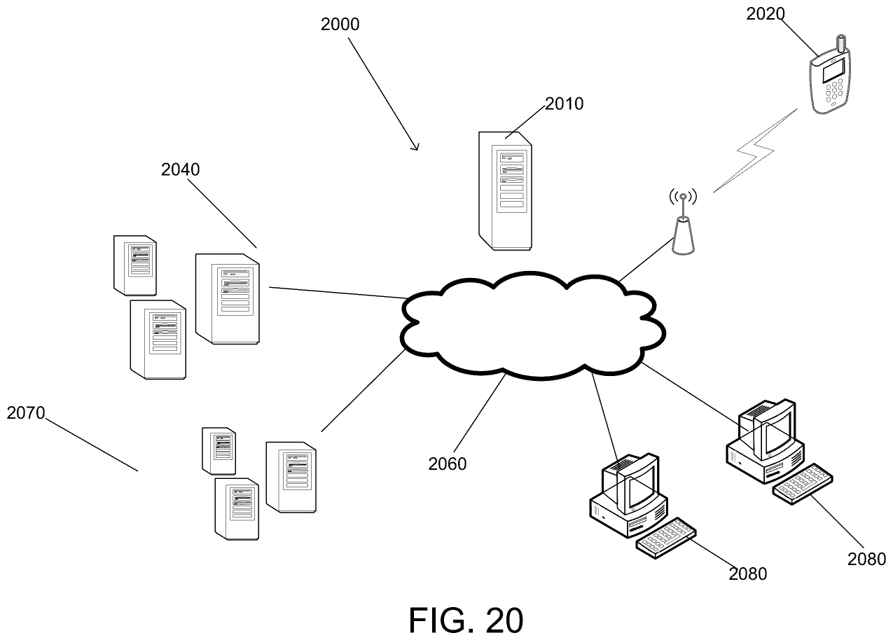

An example of a hypergraph discovery system that performs hypergraph discovery in accordance with an embodiment of the invention is illustrated in FIG. 20. Network 2000 includes a communications network 2060. The communications network 2060 is a network such as the Internet that allows devices connected to the network 2060 to communicate with other connected devices. Server systems 2010, 2040, and 2070 are connected to the network 2060. Each of the server systems 2010, 2040, and 2070 is a group of one or more servers communicatively connected to one another via internal networks that execute processes that provide cloud services to users over the network 2060. One skilled in the art will recognize that a hypergraph discovery system may exclude certain components and/or include other components that are omitted for brevity without departing from this invention.

For purposes of this discussion, cloud services are one or more applications that are executed by one or more server systems to provide data and/or executable applications to devices over a network. The server systems 2010, 2040, and 2070 are shown each having three servers in the internal network. However, the server systems 2010, 2040 and 2070 may include any number of servers and any additional number of server systems may be connected to the network 2060 to provide cloud services. In accordance with various embodiments of this invention, a hypergraph discovery system that uses systems and methods that perform hypergraph discovery in accordance with an embodiment of the invention may be provided by a process being executed on a single server system and/or a group of server systems communicating over network 2060.

Users may use personal devices 2080 and 2020 that connect to the network 2060 to perform processes that perform hypergraph discovery in accordance with various embodiments of the invention. In the shown embodiment, the personal devices 2080 are shown as desktop computers that are connected via a conventional “wired” connection to the network 2060. However, the personal device 2080 may be a desktop computer, a laptop computer, a smart television, an entertainment gaming console, or any other device that connects to the network 2060 via a “wired” connection. The mobile device 2020 connects to network 2060 using a wireless connection. A wireless connection is a connection that uses Radio Frequency (RF) signals, Infrared signals, or any other form of wireless signaling to connect to the network 2060. In the example of this figure, the mobile device 2020 is a mobile telephone. However, mobile device 2020 may be a mobile phone, Personal Digital Assistant (PDA), a tablet, a smartphone, or any other type of device that connects to network 2060 via wireless connection without departing from this invention.

As can readily be appreciated the specific computing system used to perform hypergraph discovery is largely dependent upon the requirements of a given application and should not be considered as limited to any specific computing system(s) implementation.

### 6. Hypergraph Discovery Element

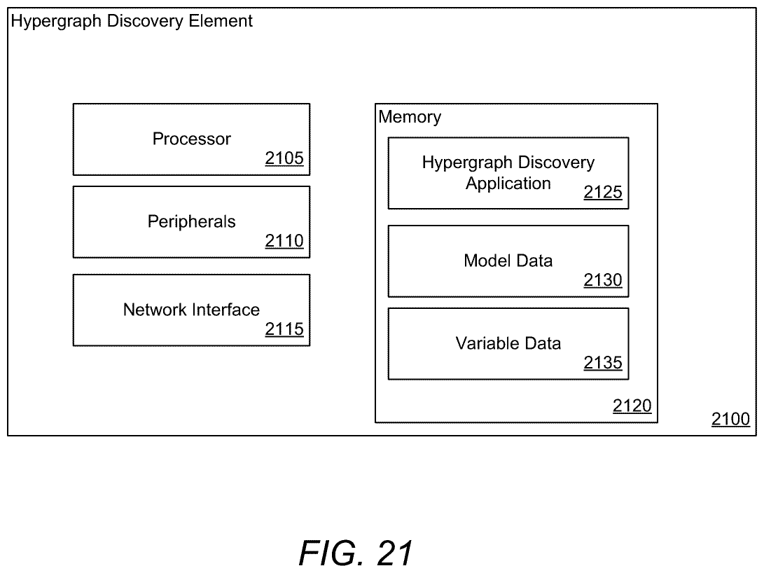

An example of a hypergraph discovery element that executes instructions to perform processes that perform hypergraph discovery in accordance with an embodiment of the invention is illustrated in FIG. 21. Hypergraph discovery elements in accordance with many embodiments of the invention can include (but are not limited to) one or more of mobile devices, cameras, and/or computers. Hypergraph discovery element 2100 includes processor 2105, peripherals 2110, network interface 2115, and memory 2120. One skilled in the art will recognize that a hypergraph discovery element may exclude certain components and/or include other components that are omitted for brevity without departing from this invention.

The processor 2105 can include (but is not limited to) a processor, microprocessor, controller, or a combination of processors, microprocessor, and/or controllers that performs instructions stored in the memory 2120 to manipulate data stored in the memory. Processor instructions can configure the processor 2105 to perform processes in accordance with certain embodiments of the invention. In various embodiments, processor instructions can be stored on the memory 2120 (or non-transitory machine readable medium).

Peripherals 2110 can include any of a variety of components for capturing data, such as (but not limited to) cameras, microphones, displays, and/or sensors (e.g., accelerometers, gyroscopes, radar, LiDAR, environmental sensors, odometers, etc.). In a variety of embodiments, peripherals can be used to gather inputs and/or provide outputs. Hypergraph discovery element 2100 can utilize network interface 2115 to transmit and receive data over a network based upon the instructions performed by processor 2105. Peripherals and/or network interfaces in accordance with many embodiments of the invention can be used to gather inputs that can be used to perform hypergraph discovery.

Memory 2120 includes a hypergraph discovery application 2125, model data 2130, and training data 2135. Hypergraph discovery applications in accordance with several embodiments of the invention can be used to perform hypergraph discovery. In numerous embodiments, hypergraph discovery applications may support other applications with discovered hypergraphs. For example, in certain embodiments, hypergraph discovery applications provide support for control applications in autonomous apparatuses by providing dynamic updates to hypergraphs used to control the apparatus based on changing conditions.

Model data in accordance with numerous embodiments of the invention can store various parameters and/or weights for various models that can be used for various processes as described in this specification. Model data in accordance with many embodiments of the invention can be updated through training on variable data captured on a hypergraph discovery element or can be trained remotely and updated at a hypergraph discovery element. In some embodiments, model data can include hypergraphs with nodes for various system variables (e.g., sensor data and outputs) and the updated connections and functions between them.

In a variety of embodiments, variable data can include data collected by a training element across a number of different variables. As described throughout this description, variable data can include data across a variety of different types, such as (but not limited to) video data, audio data, stock data, chemical data, sensor data, environmental data, social network data, system control data, etc.

Although a specific example of a hypergraph discovery element 2100 is illustrated in this figure, any of a variety of hypergraph discovery elements can be utilized to perform processes for hypergraph discovery similar to those described herein as appropriate to the requirements of specific applications in accordance with embodiments of the invention.

Although specific methods of hypergraph discovery are discussed above, many different methods of hypergraph discovery can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method of processing input data, comprising:
receiving input data at a data processing system;
providing the input data to a discovered hypergraph; and
generating an output using the discovered hypergraph;
wherein the discovered hypergraph is characterized by a plurality of relationships between a plurality of nodes that each represent a variable of a plurality of variables, where the plurality of relationships were discovered by:
selection of a kernel for a relationship between at least one node of the plurality of nodes and a set of candidate ancestors; and
pruning of the set of candidate ancestors to identify a set of minimal ancestors.

2. The method of claim 1, wherein the plurality of relationships were further discovered by selection of a different second kernel for a second relationship between a second node of the plurality of nodes and a corresponding set of candidate ancestors.

3. The method of claim 1, wherein the kernel is at least one selected from the group consisting of a linear kernel, a quadratic kernel, and a nonlinear kernel.

4. The method of claim 1, wherein generating the output comprises generating a set of control signals for controlling a physical device.

5. The method of claim 1, wherein receiving the set of input data comprises normalizing the set of input data.

6. The method of claim 1, wherein:
the selection of a kernel is based on a set of training data;
the set of training data comprises a plurality of samples;
a first sample comprises values for a first subset of the plurality of variables; and
a second sample comprises values for a different second subset of the plurality of variables.

7. The method of claim 1, wherein selection of a kernel comprises:
for each of a plurality of kernels:
computing a signal-to-noise ratio (SNR) for the relationship between the selected node and the set of candidate ancestors; and
when the SNR falls below a given threshold, selecting the kernel for the relationship between the selected node and the set of candidate ancestors.

8. The method of claim 7, wherein computing the SNR comprises:
selecting a noise prior parameter; and
performing a regression analysis with the selected noise prior parameter.

9. The method of claim 8, wherein performing the regression analysis comprises predicting a value of the selected node based on the set of candidate ancestors.

10. The method of claim 1, wherein the set of candidate ancestors comprises all of the plurality of nodes other than the selected node.

11. The method of claim 1, wherein pruning the set of candidate ancestors comprises:
identifying a least important ancestor of the set of candidate ancestors;
computing a signal-to-noise (SNR) for the relationship between the selected node and the set of candidate ancestors without the least important ancestor;
when the computed SNR exceeds a given threshold, select the set of candidate ancestors without the least important ancestor as the set of minimal ancestors; and
when the computed SNR falls below a given threshold, select the set of candidate ancestors as the set of minimal ancestors.

12. The method of claim 1, wherein pruning the set of candidate ancestors comprises:
for each of a plurality of subsets of the set of candidate ancestors, computing a noise-to-signal ratio (NSR) for the relationship between the selected node and the subset of candidate ancestors; and
identifying a particular subset of the plurality of subsets as the set of minimal ancestors based on the computed NSRs for the plurality of subsets.

13. The method of claim 12, wherein computing the NSR comprises:
selecting a noise prior parameter; and
performing a regression analysis with the selected parameter by predicting a value of the selected node based on the set of candidate ancestors.

14. The method of claim 13, wherein the NSR is a ratio of a mean and a variance for predicted values of the selected node based on the set of candidate ancestors.

15. The method of claim 13, wherein the noise prior parameter is selected based on characteristics of the kernel.

16. The method of claim 12, wherein identifying the particular subset comprises identifying an inflection point in the NSRs as a function of a number of ancestors in the subset of candidate ancestors.

17. The method of claim 12, wherein pruning the set of candidate ancestors comprises:
identifying a set of redundant candidate ancestors of the set of candidate ancestors based on the determined relationships between the plurality of nodes; and
removing at least one candidate ancestor of the set of redundant candidate ancestors from the set of candidate ancestors, wherein redundant candidate ancestors make redundant contributions to the computed NSR.

18. The method of claim 1, wherein the plurality of relationships were further discovered by:
identifying clusters of nodes of the plurality of nodes based on relationships between each node and the set of candidate ancestors of the node; and
identifying relationships between the clusters of nodes, wherein the plurality of relationships comprises:
the relationships between each node and the set of candidate ancestors of the node; and
the relationships between the clusters of nodes.

19. An apparatus comprising:
at least one processor; and
a memory;
wherein machine readable instructions stored in the memory configure the processor to perform a method comprising:
receiving input data at a data processing system;
providing the input data to a discovered hypergraph;
generating an output using the discovered hypergraph; and
controlling the apparatus based on the generated hypergraph, wherein the discovered hypergraph is characterized by a plurality of relationships between a plurality of nodes that each represent a variable of a plurality of variables, where the plurality of relationships were discovered by:
selection of a kernel for a relationship between at least one node of the plurality of nodes and a set of candidate ancestors; and
pruning of the set of candidate ancestors to identify a set of minimal ancestors.

20. The apparatus of claim 19 further comprising a set of one or more peripherals, wherein:
the input data comprises data collected from at least one peripheral of the set of peripherals; and
controlling the apparatus comprises generating control signals to control the apparatus.
